(19) United States
(12) Patent Application Publication
(10) Pub. No.: US 2026/0063438 A1
(43) Pub. Date: Mar. 5, 2026

(54) SYSTEMS AND METHODS FOR PROVIDING LOW CONNECTIVITY POINT-BASED NAVIGATION

(71) Applicant: Adeia Guides Inc., San Jose, CA (US)

(72) Inventors: Evgeny Kaminsky, Hallandale Beach, FL (US); Christopher Phillips, Hartwell, GA (US); Reda Harb, Tampa, FL (US); Charles Dasher, Lawrenceville, GA (US)

(21) Appl. No.: 18/823,509

(22) Filed: Sep. 3, 2024

(51) Int. Cl. G01C 21/36; G01C 21/16; H04W 4/02

(52) U.S. Cl. CPC G01C 21/3623; G01C 21/1656; H04W 4/025

(57) ABSTRACT

Low connectivity reference point-based navigation is provided. The disclosed systems and methods determine a location of a user device based on location information retrieved from a first locating system. Based on determining that the user device is near an area with limited connectivity to the first locating system, a sparse map is retrieved from a second locating system. Such a sparse map includes mapping information related to the area with low connectivity to the first locating system. The systems detect that the user device is near a reference point indicated in the mapping information of the sparse map. The disclosed systems detect an indicator associated with the reference point and updated mapping information associated with the indicator that includes updated location information of the user device is retrieved. The disclosed systems update the location of the user device based on the retrieved location information associated with the reference point.

### BACKGROUND

The present disclosure relates to navigation, and in particular to systems and methods for navigating in environments where traditional navigation signals are weak.

### SUMMARY

Navigation systems use signals received from satellites or other sources to locate navigation devices. For example, a ground positioning system (GPS) incorporated in a device relies on signals received from one or more satellites to determine the device's location. In another example, cellular tower locating uses cellular signals from multiple towers to triangulate the device's location. As noted, such systems rely on receiving signals from sources and when such signals are weak, blocked, and/or interrupted, locating and navigation services become inaccurate and, in some cases, unusable.

Such systems may be limited in terms of providing detailed, lane-specific guidance on multi-lane roads or distinguishing between an old road and a newly constructed parallel path, which can lead to unsafe driving conditions, especially if the driver inadvertently remains on a hazardous or decommissioned road. Further, such systems may be of little use when instructions are requested for navigating within densely constructed spaces (e.g., buildings, malls, garages, and/or underground facilities) which may have poor or no connectivity. These challenges are compounded by the need for navigation solutions to be precise and reliable and integrate seamlessly into the aesthetic fabric of the environment without compromising safety. Moreover, within indoor spaces, where traditional GPS navigation is nearly ineffective, there's a need for a system that relies on coordinates relative to an entry point rather than global coordinates. The aesthetic challenges of using reference markers in specific environments, such as retail spaces or urban roads, also call for a more holistic solution that addresses these concerns.

Another drawback to existing navigation systems is that such cannot accurately navigate drivers to available parking stalls within a parking structure. Certain parking structures incorporate systems that allow drivers to determine where available parking stalls are located. For example, some parking structures have vehicle detection sensors to determine which stall(s) are available. That information is sometimes aggregated by parking level (in a multi-level parking structure). Such systems may provide a sign indicating which floors of a parking structure have available parking stall(s) and the number of stalls available. In some such examples, the stalls themselves may have a light that indicates that certain stalls are available. However, such systems cannot provide navigational direction to the driver to navigate to the available stall(s) and it is left to the driver to move about the parking structure and find an available parking stall. Another drawback to such systems is such do not offer parking availability that is optimized to the ultimate location (e.g., store within a shopping center) that the diver desires to visit.

To help overcome these problems, systems, apparatuses, and methods are disclosed herein for providing low-connectivity point-based navigation, e.g., based on leveraging at least one reference point of a network of reference points to provide precise and reliable navigation.

For example, the disclosed systems and methods determine a location of a user device based on location information retrieved from a first locating system (e.g., a GPS system). Based on determining that the user device is near an area with limited connectivity to the first locating system, the disclosed systems and methods retrieve a sparse map from a second locating system. Such a sparse map includes mapping information related to the area with low connectivity to the first locating system. The disclosed systems and methods detect that the user device is near a reference point indicated in the mapping information of the sparse map. The disclosed systems and methods detect an indicator associated with the reference point. The disclosed systems and methods retrieve updated mapping information associated with the indicator that includes updated location information of the user device. The disclosed systems and methods update the location of the user device based on the retrieved location information associated with the reference point indicator. In some implementations, the disclosed systems and methods generate for display navigational direction based on the updated location of the user device. Such features and techniques are an improvement over existing systems because they enable the ability to accurately locate the user equipment device and provide precise navigation in areas where GPS connectivity is limited or non-existent. Such techniques may enable providing reliable indoor navigation, even while GPS signals are not available, to provide efficient, intuitive, and safe mechanism to navigate areas of poor or no connectively, e.g., complex indoor layouts. The present systems and methods also ensure high precision in location tracking. Additionally, the disclosed features include updating navigation coordinates in real time as the object aligns with predefined reference point indicators, ensuring seamless navigation through complex environments.

In an implementation, a user equipment device (e.g., a navigation system of a vehicle, a mobile device equipped with a navigation system, or any other device capable of implementing a navigational system) halts near a barrier to log its position. In some implementations, the barrier is near a location with known low connectivity to navigational systems. For example, at the entrance of a multi-story parking structure known for having poor GPS connectivity. The system captures the user equipment device's relative location, calculates the distance and radial angle to a reference point, and acquires initial XYZ or geographical coordinates. This process may involve real-time data extraction by scanning, e.g., a QR code, applying watermark removal, or using steganography techniques for images. Alternatively, data can be accessed from an offline database via, e.g., an image-linked URL. In such implementations, the URL directs to a file, e.g., a JSON file, containing XYZ coordinates or geolocation data in, e.g., Decimal Degree format, enabling precise location identification.

In some implementations that include a camera installed within a vehicle (e.g., integrated within a user equipment device (e.g. a cell phone) or a camera installed in the vehicle), techniques of the present disclosure provide for a one-time calibration (e.g., in a laboratory, during manufacture, or during initialization). For example, because the camera's fixed position in the vehicle is maintained throughout its use, and the dimensions and placements of reference point indicators in various environments are standardized or known, the techniques herein can determine the vehicle's position relative to those reference point indicators. Such embodiments minimize or eliminate the need for recalibration each time a vehicle or user equipment device enters a new area equipped with reference navigation points or travels to an area with low connectivity to other locating and navigational systems. Although not necessary, in some implementations, the user equipment device may recalibrate or have its calibration verified during the life of its use, for example, at predetermined intervals (e.g., service intervals), upon the occurrence of an event (e.g., the vehicle in which the user equipment is used experiences an accident or other event that may cause the user equipment device to require recalibration), when the accuracy of the system falls outside of acceptable parameters (e.g., due to skew), or at any time when the user equipment device exhibits inaccuracy.

As the user equipment device moves through the area with low connectivity, the vehicle's location (e.g., navigation coordinates) may be dynamically updated based on the alignment with certain conditions, such as the positioning of reference point indicators, e.g., QR code signs or screens at consistent heights relative to a moving object within the camera's frame.

In an example implementation embodied by a vehicle navigation in a parking structure with no GPS connectivity, upon embarking on the journey (e.g., the journey or destination including areas with known poor or no GPS connectivity), the vehicle's navigation system (e.g., the user equipment device) proactively downloads a series of control points from, e.g., a designated URL, which may link to webpages hosting JSON files containing, e.g., XYZ coordinates. In such embodiments, the vehicle may include its own network connectivity (e.g., internet connection) that is used to download relevant information. Alternatively, coordinates can be embedded in reference point indicators that include, e.g., QR codes or images using steganography or watermarking, negating the need for the connection but reducing flexibility, as such QR codes may be location specific. Embedding links to web pages that direct to servers hosting JSON files may also offer additional information, e.g., advertisements, enhancing the value of the navigation system beyond mere directional guidance. These coordinates precisely map the driver's intended route from the entrance of the parking structure to a desired location, for example, a particular parking stall or a point of interest within or near the parking structure. In such implementations, the user equipment device may require network connectivity to download information prior to entering the area with no connectivity. Alternatively, such areas with no GPS connectivity may nevertheless have network connectivity. In some implementations, the systems and methods of the present disclosure enable the system to determine a specific parking stall to which location the vehicle is guided. In such implementations, the system provides navigational directions from the entrance of the parking structure to the vehicle's designated parking stall, including alternate routes for any deviations. Simultaneously, depending on the system's configuration, a comprehensive map of the area between these control points may be downloaded to the vehicle's navigation system, available in either two-dimensional or three-dimensional formats.

In some implementations, a seamless mode transition is initiated as the vehicle approaches or enters a structured environment, ensuring uninterrupted navigation when GPS and/or network signals weaken or become unavailable, or when the navigational system enters into a parking function. This switch is facilitated by the vehicle's location as determined by indoor navigation using, e.g., QR code captured information, sensors (e.g., vehicle detection sensors integrated within the area), predicted through GPS data, and/or inertial navigation, refining the transition process.

In some implementations, parking structures have incorporated sensors and indicators that, for example, allow drivers searching for a parking stall to identify empty stalls. In some implementations, such sensors are located at each parking stall and typically use cameras or range sensing devices to determine if the parking space is occupied. While visual indicators are helpful in allowing drivers entering a parking structure to know which levels (in a multi-level parking structure) have available parking stalls, such systems do not allow the drivers to see where in the parking structure the empty stalls are located. In some implementations, a map (e.g., of the parking structure that may include surrounding points of interest) is presented and a desired location is selected. The system may guide the vehicle to the nearest available parking stall.

In some implementations, spatial coordinate data for each parking sensor is combined with a simultaneous localization and mapping (SLAM) map where the coordinates are compatible with the SLAM coordinate system, allowing vehicles to receive indoor navigational turn-by-turn directions directly to a specific (e.g., available) stall within the parking structure. In some implementations, a sparse two-dimensional mapping system generated from three-dimensional SLAM maps offer driving directions to the most desirable locations within the parking structure.

In such implementations, techniques of the present disclosure allow the user to locate and navigate to an empty stall amongst many unavailable stalls quickly and efficiently, even when the nearest available stall is located on a different floor/level than the vehicle. This is an example of a situation where GPS is not available, and network connectivity may be extremely limited or lost resulting in a cloud-based SLAM system being unavailable for mapping and localization.

In some implementations, the user equipment switches between a first navigational system (e.g., GPS) to a second navigational system (e.g., the disclosed system for providing low connectivity point-based navigation) that provides directions and/or parking guidance, e.g., when the GPS signal is weak or lost. In such an implementation, reference point indicators are strategically placed within the parking area, facilitating navigation without needing GPS connectivity. Additionally, using the techniques of the present disclosure along with, e.g., an Inertial Measurement Units (IMU) (e.g., included in a smartphone or a vehicle's built-in navigation system) may enhance precision in navigating between reference point indicators.

In some implementations, 2D or 3D maps of the parking structure are loaded into a navigation system, pinpointing reference point indicators and indicating available parking stalls. This feature is beneficial if, for example, a map has not been previously downloaded or where there has been a change in the availability of parking spaces, necessitating an update. The system's ability to adapt to real-time parking stall availability ensures that drivers are directed efficiently to available stalls without delay.

In some implementations, techniques of the present disclosure offer the added convenience of showing drivers the specific location of a specific parking stall, for example, when the parking is intended to be near a particular business or destination within a complex.

For example, the disclosed system identifies a specific location within an area that includes multiple destinations, e.g., a shopping mall or complex. The location may be identified via user input. In such embodiments, the system provides guidance to the available parking stall nearest to the identified location, making vehicle's navigation seamless and time efficient. Such implementations enhance the navigation experience within the confines of a parking structure and significantly improve overall customer satisfaction by reducing the time and effort spent searching for available parking stalls.

In some implementations, a mobile device (e.g., a cellular telephone, tablet, or other device) is used along with the techniques of the present disclosure. In such an implementation, the mobile device is calibrated by, for example, capturing a QR code with the mobile device's camera. For example, the user interface (UI) of the mobile device may display the QR code within a designed area (e.g., a green square) on the device's screen, indicating that the QR code is properly framed and thus the mobile device is properly oriented. In such an implementation, the mobile device may be mounted in a movable fixture, e.g., a phone cradle installed in the vehicle (e.g., attached to the vehicle's windshield), offering a frontal view of a QR code sign that is visible from the vehicle's cabin. Such a reference point indicator, e.g., that includes a reference QR code plate, may be located at the entrance of, e.g., a parking structure that is known to have poor GPS and/or poor/no mobile connectivity, for example, an underground parking structure. Additional QR code signs may be located throughout the parking structure. During the initialization process, the barrier precisely marks the QR code's position and may further include a visual notification of the vehicle's entrance into the parking structure (e.g., lines or other indicators painted on the surfaces of the ground or walls, or a color light or laser may be utilized to indicate or highlight lines on the surface). In such implementations, vehicles are instructed to approach the barrier as closely as possible to complete the initialization process. Such an initialization promotes accuracy in pinpointing the vehicle's coordinates in relation to QR signs within the parking structure.

Continuing with the previous example, vehicles are guided from the starting initialization point to an available parking stall, navigating between reference point indicators based on the maps and information gained from the QR code feature reference point indicators within the parking structure. Although such implementations may be achieved without using GPS locating information, such GPS or other navigational information may be incorporated into the techniques of the present disclosure without departing from the contemplated implementations. In some implementations, reference point indicators may be located near intersections such that the vehicle's location may be tracked when entering and departing such intersections.

In an implementation, techniques of the present disclosure include determining the distance from an object based on known criteria. For example, the techniques herein may use a camera in a fixed position to determine the distance and/or relative orientation to a reference point indicator. In such an implementation, pre-determined indicator sizes are used to create a database of quadrilateral shapes corresponding to different distances and/or orientations relative to the reference point indicators. In such implementations, a sign, monitor, or other reference point indicator has known dimensions and a known orientation. When the indicator is captured by a camera, computer vision techniques may be applied to extract a quadrilateral shape representing the edges of the indicator. Using the size, shape, orientation, and/or configuration of the extracted quadrilateral, the relative distance and orientation to the indicator is determined. In some implementations, the system includes a library of quadrilaterals in various sizes and shapes, each having associated information that includes a known distance and orientation from a vehicle or other user equipment device. In such implementations, the extracted quadrilateral from a captured image of an indicator may be compared to those in the library to determine the distance and/or orientation of the vehicle or user equipment device relative to the reference point indicator.

In another implementation, computer vision techniques may be implemented in place of or in addition to other range estimating techniques discussed herein. For example, pose estimation may be implemented. Pose estimation includes detecting the position and/or orientation of an object by, e.g., tracking and/or predicting the location of specific key points like edges, lines, markers, etc. Based on the detected relative orientation of the key points, the system is able to determine the distance and/or orientation relative to indicators.

In another implementation, the disclosed system and methods determine a location of a user device based on location information retrieved from a first locating system (e.g., a GPS system). Based on determining that the user device is near an area with limited connectivity to the first locating system, the disclosed systems and methods retrieve a sparse map from a second locating system. Such a sparse map includes mapping information related to the area with low connectivity to the first locating system. The disclosed systems and methods detect that the user device is near a reference point indicated in the mapping information of the sparse map. The disclosed systems and methods detect an indicator associated with the reference point. The disclosed systems and methods retrieve updated mapping information associated with the indicator that includes updated location information of the user device. The disclosed systems and methods update the location of the user device based on the retrieved location information associated with the reference point indicator. In some implementations, the disclosed systems and methods generate for display navigational direction based on the updated location of the user device.

In some implementations, the reference point indicator is a quick response (QR) code comprising locating information, for example, coordinates relating to one or more reference point indicators. In other implementations, the QR code may comprise information related to a uniform resource identifier (URI), with which the user equipment device retrieves updated mapping information including accessing information using the URI.

In some implementations, the reference point indicator is a wireless signal, and retrieving updated mapping information includes retrieving information from the wireless signal.

In some implementations, the reference point indicator is a wireless signal having information related to a uniform resource identifier (URI) and retrieving updated mapping information includes accessing information using the URI.

In some implementations, the reference point indicator is a visual object, and updating the location of the user device is further based on determining the user device's location relative to the visual object.

In some implementations, the disclosed systems and methods additionally receive information from an inertial measurement unit (IMU) associated with the user device, including IMU location information. The disclosed systems and methods calibrate the IMU location information based on the updated location of the user device.

In some implementations, updating the location of the user device is further based on the IMU location information.

In some implementations, the first locating system is a global positioning system (GPS). In some implementations, the navigational directions are displayed using a first application. In some implementations, the disclosed systems and methods switch, based on determining that the user device entered the area with limited connective to the first locating system, from displaying the navigational directions using the first application (e.g., a GPS system application) to displaying the navigational directions using a second application.

### BRIEF DESCRIPTION OF THE DRAWINGS

The above and other objects and advantages of the disclosure will be apparent upon consideration of the following detailed description, taken in conjunction with the accompanying drawings, in which:

FIG. 1 depicts an illustrative diagram of a system for low connectivity reference point-based navigation, in accordance with embodiments of the disclosure;

FIG. 2 depicts an illustrative process of a system for low connectivity reference point-based navigation, in accordance with embodiments of the disclosure;

FIG. 3 depicts an example user equipment device of a system for low connectivity reference point-based navigation, in accordance with embodiments of the disclosure;

FIG. 4 depicts an illustrative process for navigating to an available parking stall using a system for low connectivity reference point-based navigation, in accordance with embodiments of the disclosure;

FIG. 5 depicts an illustrative diagram illustrating a user equipment device approaching a reference point indicator of a system for low connectivity reference point-based navigation, in accordance with embodiments of the disclosure;

FIG. 6 depicts an illustrative process of updating a map of system for low connectivity reference point-based navigation, in accordance with embodiments of the disclosure;

FIGS. 7A through 7D depict an illustrative diagram of a system for low connectivity reference point-based navigation, in accordance with embodiments of the disclosure;

FIGS. 8A and 8B depict an illustrative diagram of a system for low connectivity reference point-based navigation, in accordance with embodiments of the disclosure;

FIGS. 9A through 9F depict an illustrative diagram of a system for low connectivity reference point-based navigation, in accordance with embodiments of the disclosure;

FIGS. 10A through 10D depict an illustrative diagram of a system for low connectivity reference point-based navigation, in accordance with embodiments of the disclosure; and

FIG. 11 depicts an illustrative diagram of a system for low connectivity reference point-based navigation, in accordance with embodiments of the disclosure.

### DETAILED DESCRIPTION

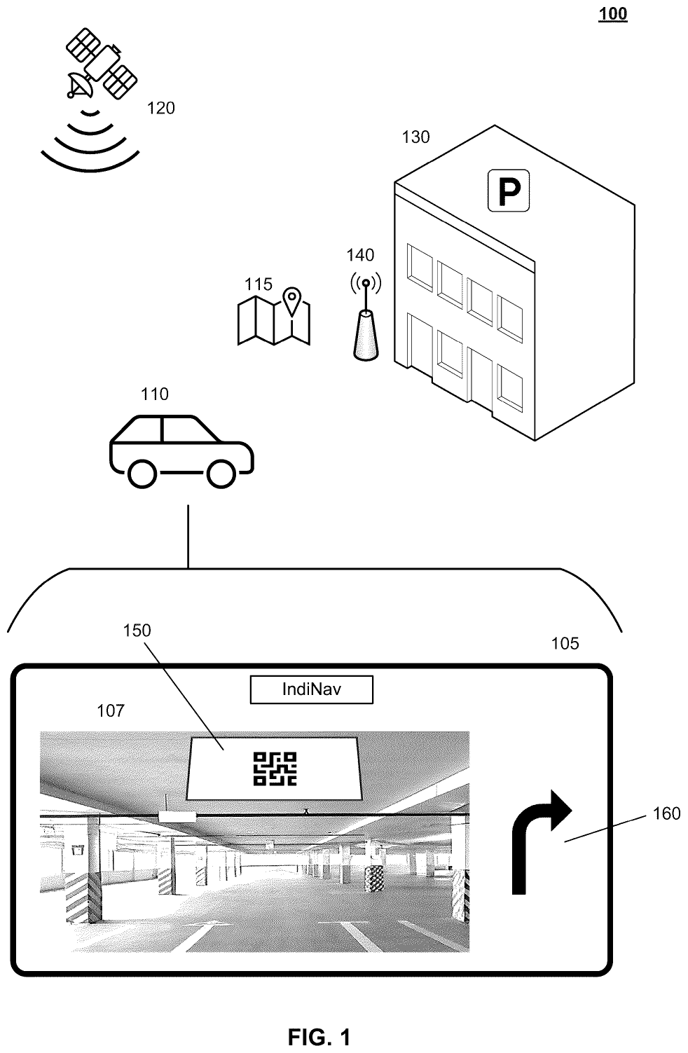

In an example embodiment of the present disclosure and with reference to FIG. 1, the system for providing low connectivity point-based navigation 100 includes user equipment device 105 (that may include display 107), vehicle 110, sparse map 115, GPS system 120, structure 130, and antenna 140. In some embodiments, user equipment device 105 is associated with vehicle 110. In some embodiments, user equipment device 105 includes a navigational system, for example, global positioning system (GPS) navigation. In such embodiments, user equipment device 105 receives GPS information from GPS system 120. User equipment device 105 includes display 107 and, in some embodiments, displays navigational direction 160.

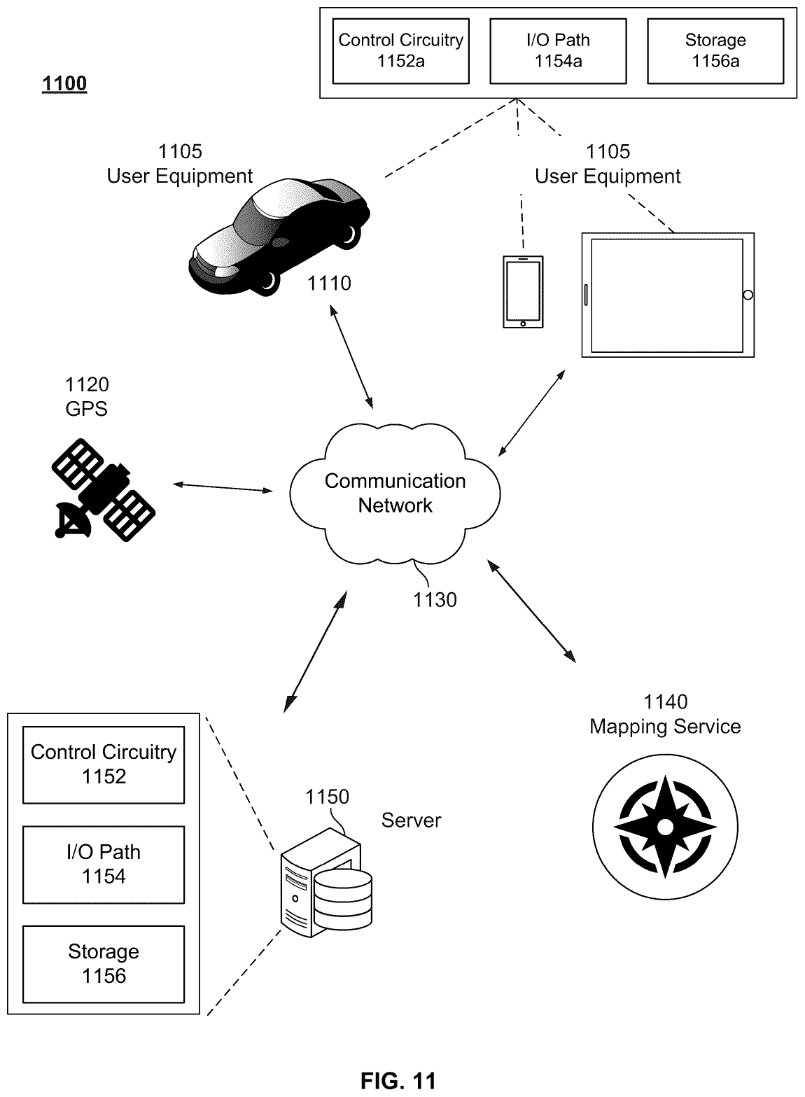

The techniques described herein may be implemented, at least in part, using system 100 which may be executed at least in part on user equipment device 105 and/or at one or more remote servers and/or databases (e.g., server 1150 of FIG. 11), and/or at or distributed across any of one or more other suitable computing devices, in communication over any suitable number and/or types of networks (e.g., the Internet, satellite, cellular). The system may be a stand-alone application, or may be incorporated as part of any suitable application or system. The system may comprise or employ any suitable number of displays; sensors or devices such as those described in FIGS. 1-11; or any other suitable software and/or hardware components; or any combination thereof.

In operation, vehicle 110 approaches structure 130, embodied by a parking structure as illustrated in FIG. 1. In such an embodiment, connectivity with GPS system 120 is diminished, limited, or nonexistent in and around parking structure 130. In some embodiments, system 100 determines whether connectivity with GPS system 120 is diminished, limited, or nonexistent. For example, system 100 may retrieve information from a database indicating that user equipment devices (e.g., user equipment device 105) have experienced connectivity issues when in or around parking structure 130. In such embodiments, historical instances of user equipment device 105 experiencing connectivity issues with GPS system 120 are stored. Alternatively or in addition, instances of other users' GPS systems or other navigational devices experiencing connectivity issues with GPS system 120 may also be stored. Although GPS system 120 may be illustrated and described as being embodied by a global positioning satellite system, system 120 may be embodied by any locating or navigational system, without departing from the contemplated embodiments.

When vehicle 110 approaches the entrance of parking structure 130, system 100 detects the presence of vehicle 110 and downloads sparse map 115. System 100 may detect the presence vehicle 110 in a variety of ways. In some embodiments, system 100 detects the presence of vehicle 110 by comparing the location of vehicle 110 (e.g., using GPS system 120) to the known location of parking structure 130. In other embodiments, system 100 detects the presence of vehicle 110 by using sensors. In such embodiments, system 100 may implement any sensor capable of detecting the presence, location, and/or orientation of vehicle 110. For example, system 100 may implement a microwave sensor, and infrared photo beam sensor, a wireless magnetometer, a gate sensor, an optical sensor, a car counting sensor, a car warning system sensor, a license plate recognition sensor, or other vehicle detection sensor to detect the presence, location, and/or orientation of vehicle 110, without departing from the contemplated embodiments. In some embodiments, system 100 detects the presence of vehicle 110 by it implementing a parking function or parking mode (e.g., upon receiving a user input such as a voice command or selection of a user selectable element on a user interface)

When the presence of vehicle 100 is detected near parking structure 130, system 100 accesses sparse SLAM map 115. In some embodiments, sparse SLAM map 115 is stored locally to vehicle 110. For example, sparse SLAM map 115 may be stored in a memory located in vehicle 110 or otherwise associated with user equipment device 105. In some embodiments, sparse map 115 is stored in a memory attached to or integrated within user equipment device 105. Alternatively, or in addition, sparse SLAM map 115 may be accessed from another user device, for example, a cellular mobile telephone, or other mobile device associated with the user of vehicle 110, vehicle 110, user equipment 105, or a user account associated with any of such examples. In some embodiments, system 100 accesses sparse map 115 using a data network connected to user equipment device 105. For example, sparse map 115 may be accessed using a cellular network, internet network (e.g., a Wi-Fi, LAN, WLAN, WAN, or other network), or other data network to which user equipment device 105 and/or vehicle 110 is connected.

In some embodiments, system 100 additionally includes antenna 140 with which the presence of vehicle 110 may be detected and/or sparse map 115 is accessed. Antenna 140 may be embodied by any device or system capable of transferring information. For example, antenna 140 may be embodied by a wireless access point to which vehicle 110 and/or user equipment device 105 connects. In such an embodiment, when the presence of vehicle 110 is detected, vehicle 110 connects to antenna 140 and accesses sparse map 115. Sparse map 115 may be stored at a memory (local or remote) associated with antenna 140, parking structure 130, or both. Alternatively, antenna 140 accesses sparse map 115 from a memory located remotely from antenna 140 and/or parking structure 130.

In some embodiments, system 100 includes a device capable of measuring force, angular rate, acceleration, orientation, and other characteristics of a body. For example, system 100 may include an inertial measurement unit (IMU) attached to or otherwise associated with vehicle 110, and/or user equipment device 105. In such embodiments, user equipment device 105 and/or vehicle 110 are able to determine its location using such an IMU. The IMU information may be used in conjunction with other techniques discussed herein. For example, system 100 may use the data from an IMU to update, augment, verify, calibrate, or otherwise supplement locating data. In some embodiments, the IMU information may be used to calibrate the locating techniques discussed herein. In other embodiments, the IMU data may be used to update certain locations (e.g., locations of the vehicle, reference point indicators, roadways, or any other relevant information).

Once vehicle 110 enters parking structure 130, system 100 determines the location of user equipment device 105 and/or vehicle 110 using sparse map 115 and reference point indicators 150 distributed at known locations in an around parking structure 130. In some embodiments, user equipment device 105 displays navigational direction 160. User equipment device 105 may optionally include display 107. As illustrated in FIG. 1, display 107 displays a video captured using a camera oriented in a frontal direction of vehicle 110. In some embodiments, the camera used to capture the video may be integrated or installed into vehicle 110, for example, a forward-facing camera installed at the factory that produced vehicle 110. Alternatively, the camera may be integrated into user equipment device, for example, a camera integrated into a cellular phone or other mobile device associated with the user of vehicle 110. Although reference point indicator 150 may be illustrated and described as being embodied by a sign displaying a QR code, reference point indicator 150 may be embodied by any indicator, as discussed herein.

As vehicle 110 continues to move within parking structure 130, system 100 detects reference point indicators 150 and updates the vehicle's 110 location within parking structure 130. In some embodiments, the location of vehicle 110 is displayed on an interactive map displayed on a display associated with vehicle 110 or user equipment 105, for example, display 107.

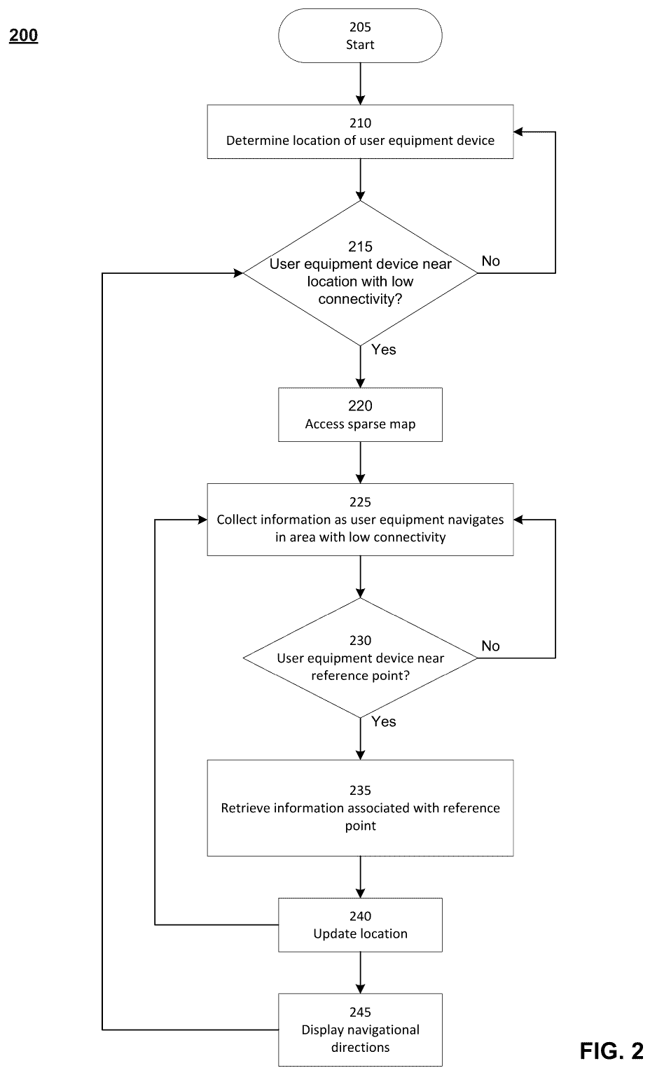

FIG. 2 illustrates an example process for providing low connectivity point-based navigation 200, according to various embodiments of the present disclosure. At 205, process 200 starts. In some embodiments, process 200 starts when it detects that the vehicle (e.g., vehicle 110) is approaching an area with low connectivity to a navigational system. In other embodiments, process 200 starts based on receiving a user selection. In such an example, a user may input into a user interface a start command to system 200. In other embodiments, system 200 displays a prompt at a user interface indicating that the vehicle is going to enter into a location with limited connectivity to navigational systems. In such an embodiment, the user may interact with the user interface to confirm that process 200 is to start.

At 210, process 200 determines the location of the user equipment device. In some embodiments, process 200 determines the location of the user equipment device using a GPS system or other locating system (e.g., an IMU associated with the vehicle). In other embodiments, process 200 determines the location of the user equipment device using a sensor or other detector that determines the vehicle's location relative to an area with known connectivity issues. For example, in an embodiment where the vehicle is entering a parking structure, process 200 may detect the vehicle's location using a sensor built into or located near the entrance of the parking structure. In such an example, process 200 may rely exclusively on the vehicle detector or, alternatively, additionally use the location of user equipment device as determined from a GPS or other locating system.

At 215, process 200 determines whether the user equipment device is near a location with low connectivity. As discussed herein, process 200 may use locating information from a sensor that determines the user equipment device is near an area with low connectivity to a GPS or other locating system. In the event that process 200 determines that user equipment device is not near a location with low connectivity, process 200 returns to 210. In the event process 200 determines that the user equipment device is near a location with low connectivity, process 200 proceeds to 220.

At 220, process 200 accesses a sparse map. The sparse map includes mapping information related to the area with low connectivity (for example, as referenced with respect to 210 and 215). In some embodiments, the sparse map contains minimal information to minimize the size of the electronic file(s) associated with the sparse map. In other embodiments, the sparse map may contain information beyond what is strictly necessary to effectuate navigation within the area with low connectivity. In other embodiments, the sparse map is modified based on, e.g., a user profile associated with the user equipment device. In such embodiments, the sparse map may include points of interest, previously visited locations, popular locations, particular routes to navigate, past or present locations of vehicles, parking locations, parking stalls, or any other information relevant to the user equipment device's navigation within the area of low connectivity. Such a modified sparse map may be used to modify another sparse map(s), for example, merging one or more features of a modified sparse map with a generalized sparse map available for download by other users. In some embodiments, process 200 proactively accesses (e.g., downloads) one or more sparse maps based on receiving an input from a user. For example, a user may input a destination into a navigation system. Process 200 may determine that, based on the input destination and a current location of the user equipment device, one or more sparse maps that relate to possible navigational routes exist. Process 200 may then proactively download the relevant sparse map(s) in anticipation of travelling through areas with low or no GPS connectivity.

At 225, process 200 collects information as the user equipment device (e.g., user equipment device 105 of FIG. 1) navigates in area with low connectivity. In some embodiments, the user equipment device collects information from an IMU that indicates the location of the user equipment device. Additionally, the user equipment device may detect reference point indicators by, e.g., capturing an image/video of such indicator and processing the information associated with the indicators to determine its location.

At 230, process 200 determines whether the user equipment device is near a reference point indicator. For example, process 200 may detect the reference point indicator visually by, for example, capturing an image or a video of it. An such an example, the user equipment device may process images and/or video captured with a camera to detect the reference point indicator. In another example, the reference point indicator may broadcast a signal that is detected by the user equipment device. For example, the reference point indicator may broadcast a Wi-Fi or Bluetooth signal that is detected by the user equipment device. Although a Wi-Fi or Bluetooth signal may be illustrated and described, any type of signal that is detectable by the user equipment device and is capable of one way or multi-way communication may be implemented without departing from the contemplated embodiments. In the event process 200 determines that the user equipment device is not near a reference point indicator process 200 may return to 225. In the event process 200 determines that the user equipment device is near a reference point indicator, process 200 may proceed to 235.

At 235, process 200 retrieves information associated with the detected reference point indicator. In some embodiments, the user equipment device proactively downloads a series of control points from, e.g., a designated URL, which may link to webpages that direct to one or more memories (e.g., servers) hosting JSON files containing, e.g., XYZ coordinates. Alternatively or in addition, coordinates can be embedded in reference point indicators that include, e.g., QR codes or images using steganography or watermarking, negating the need for the connection but reducing flexibility, as such QR codes may be location specific. However, embedding links to web pages hosting JSON files may also offer additional information, e.g., advertisements, enhancing the value of the navigation system beyond mere directional guidance. Such coordinates precisely map the driver's intended route from the entrance of the parking structure to a desired location, for example, a particular parking stall or a point of interest near the parking structure. In some embodiments, the process 200 enables the system to determine a specific parking stall to which location the vehicle is guided. In such embodiments, the system provides navigational directions from the entrance of the parking structure to the vehicle's designated parking stall, including alternate routes for any deviations. In some embodiments, information associated with the reference point is retrieved from a local memory. In other embodiments, information associated with the reference point is retrieved from a remote memory.

At 240, process 200 updates the location of the user equipment device relative to reference point indicators and the sparse map (e.g., the sparse map accessed at 220). In some embodiments, the user equipment device uses information from, e.g., an IMU to determine the user equipment device's movement as it moves through the area with low connectivity. However, the locating information from the IMU may be inaccurate. As the user equipment device continues to move through the area, the inaccuracies from the IMU compound thus resulting in a functional difference between the user equipment device's determined location versus its actual location within the area (sometimes referred to as skew). When the user equipment device detects the reference point indicator, the user equipment device may process the information from the reference point indicator that indicates a precise location of the user equipment device in the area of low connectivity. The user equipment device may then correct the inaccuracies (or skew) by updating the location of the user equipment device. The user equipment device can repeat this each time it encounters a reference point indicator. In this way, process 200 periodically updates the location of the user equipment device as it moves through the area with low connectivity, thereby enhancing the accuracy of the navigational system despite not having connectivity to GPS signals. At the conclusion of 240, process 200 may optionally return to 225 where it collects information locating information as the user equipment device navigates in the area with low connectivity. In some embodiments, at the conclusion of 240, process 200 returns to 215. In other embodiments, process 200 proceeds to 245.

At 245, process 200 displays navigational directions. In some embodiment, process 200 optionally displays navigational directions to guide the user equipment device to a location. For example, the user equipment device may display navigational directions to an available parking stall or a particular store. In other embodiments, process 200 optionally displays the user equipment device's location on overlaid play map of the area. In such embodiments, navigational directions are optional not be displayed. At the conclusion of 245, process 200 Bristol returns to 215.

The features and techniques described with respect to process 200 may be implemented, at least in part, using system 100, which may be executed at least in part on user equipment device 105, 305, 505, 705, 805a-g, 905a-b, 1005, 1105, and/or at one or more remote servers and/or databases (e.g., server 1150 of FIG. 11), and/or at or distributed across any of one or more other suitable computing devices, in communication over any suitable number and/or types of networks (e.g., the Internet, satellite, cellular). Process 200 may be implemented as a stand-alone application, or may be incorporated as part of any suitable application or system. Process 200 may comprise or employ any suitable number of displays; sensors or devices such as those described in FIGS. 1-11; or any other suitable software and/or hardware components; or any combination thereof.

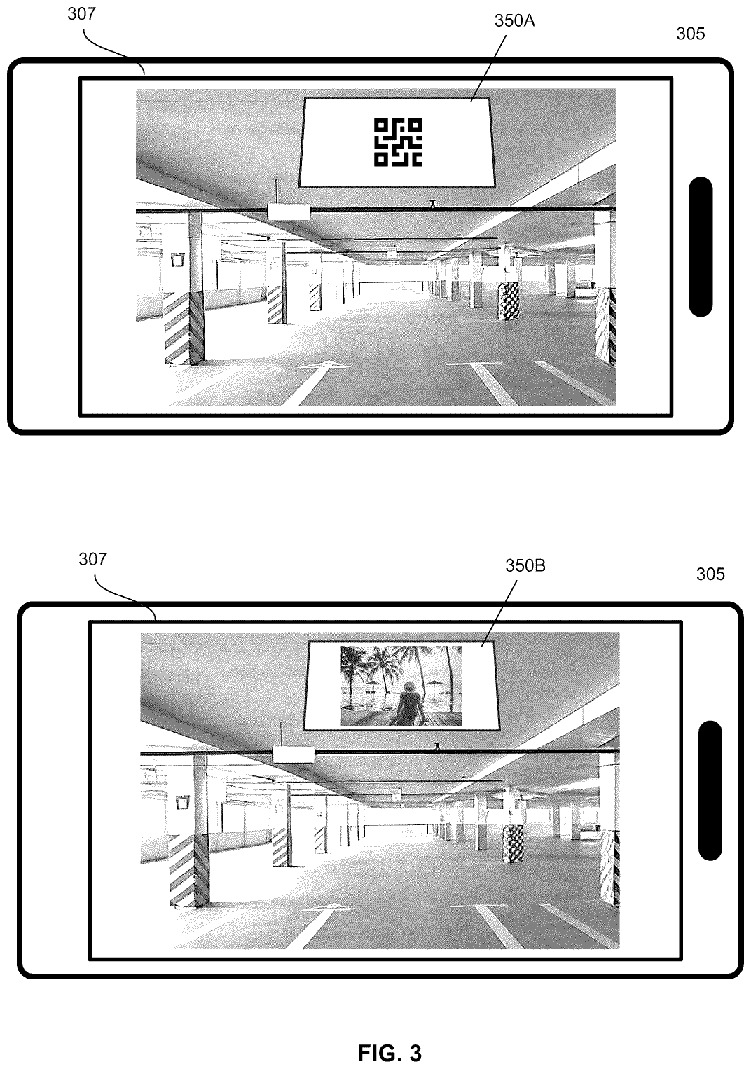

FIG. 3 illustrates example reference point indicators, according to various embodiments of the present disclosure. As illustrated, user equipment device 305 includes display 307. Although not necessary for implementation, display 307 depicts a video feed captured by a camera, for illustration purposes. Such a camera may be integrated within a vehicle or a mobile device and oriented in a direction of travel (e.g., forward facing). Additionally, multiple cameras may be used to capture multiple video streams to increase accuracy, provide redundancy, and/or to enable simultaneous detection of multiple reference point indicators. Although user equipment device 305 may be illustrated and described as being embodied by a cellular telephone, user equipment device 305 can be embodied by any device capable of implementing the techniques discussed herein. For example, user equipment device 305 may be embodied by a vehicle navigation system, a vehicle infotainment system, a tablet, a dedicated mobile GPS device, or any other suitable device.

As illustrated, reference point indicator 350A is embodied by a QR code displayed on signage located near the ceiling of a parking structure. Although reference point indicator 350A, 350B may be illustrated and described as being embodied by a particular type and located in a particular location or oriented in a particular direction, reference point indicators may be of any type, located anywhere, and oriented in any direction, without departing from the contemplated embodiments. In some embodiments, such a QR code may, when processed, update the location of user equipment device 305 relative to the reference point indicator 350A. In such embodiments, reference point indicator 350A, when scanned and processed, provide information to the user equipment device 305 related to the device's 305 location relative to the reference point indicator 305A. In this way, user equipment device 305 processes information to determine and/or refine its location relative to reference point indicators 350A, 350B.

Reference point indicators 350A, 350B need not be embodied by a QR code or even recognizable as a reference point indicator. For example, reference point indicator 350B is illustrated has a photo of a person sitting on a beach that is displayed on signage located near the ceiling of a parking structure. In such an embodiment, user equipment device 305 detects reference point indicator 350B by, e.g., capturing an image or in a video feed.

In some embodiments, user equipment device 305 is predisposed to detecting and examining images captured in a particular portion of the frame (e.g., the top half) to minimize the computational resources and increase accuracy. In embodiments that use a camera(s) integrated into the vehicle to capture the reference point indicator 350A, 350B, the camera's placement and/or viewing angle may be set to ensure capturing the reference point indicator 350A, B in the field of view, or at a specific location in the field of view.

In embodiments where the user equipment device is embodied by a mobile telephone, the user may be prompted to locate the phone in a specific location relative to the vehicle such that it is optimally positioned to detect the reference point indicator. For example, when the navigation system is initialized, the user may be prompted to orient the phone in a specific manner. In such an embodiment, when the vehicle first approaches the structure or area with known low connectivity, a light, laser, arm, line, or other indicator may be used to indicate a specific location/orientation that the vehicle should be to initialize the system. Additionally, the user may be presented with a QR code or other reference point indicator that is used to align and/or orient the camera and/or user equipment device. The user interface of the user equipment device may then indicate whether the camera/device is properly aligned. For example, the user interface may display a box in which the QR code or other reference point indicator is to be depicted when the camera/device is properly aligned. Such an example may further display the indicator as aligned or unaligned, e.g., the box is red when not aligned and green when properly aligned.

Once captured, reference point indicator 350B is processed to determine that it represents a known location within the parking structure. To implement such processing for example, user equipment device 305 includes a library of images, each representing a known location. When user equipment device 305 detects a reference point indicator (for example, reference point indicator 305B), user equipment device 305 analyzes the image and compares that image to the library of images. When the detected image matches an image in the library of images, user equipment device 305 updates its location based on the known location of the image in the library within the parking structure. In this way, user equipment device 305 is able to use seemingly innocuous images as reference point indicators. Such embodiments increase the aesthetic appeal of reference point indicators and also discourage tampering because such reference point indicators are not immediately recognizable as being reference point indicators.

In some embodiments, user equipment device 305 detects reference point indicators 350A, 350B using techniques other than visual. For example, reference point indicators 350A, 350B may include wireless connectivity devices that transmit or broadcast signals that are received by, e.g., user equipment device 305. In such embodiments, reference point indicator 350A, 350B may passively transmit locating information that is processed and used to update the location of user equipment device 305. In other embodiments, reference point indicators 350A, 350B include wireless transceivers that send and receive information. In such an embodiment, user equipment device 305 may receive signals from reference point indicators 350A, 350B. Based on processing the information contained in those signals, user equipment device 305 may then transmit a signal that is received by reference point indicator 350A, 350B. In such embodiments, user equipment device 305 is able to send information to a database that updates certain information, for example, locating information related to the structure, the location of user equipment device 305, and/or reference point indicator 350A, 350B. In some embodiments, reference point indicators may optionally be illustrated and described as a feature point (e.g., as referenced in some SLAM systems available in the art), without departing from the contemplated embodiments.

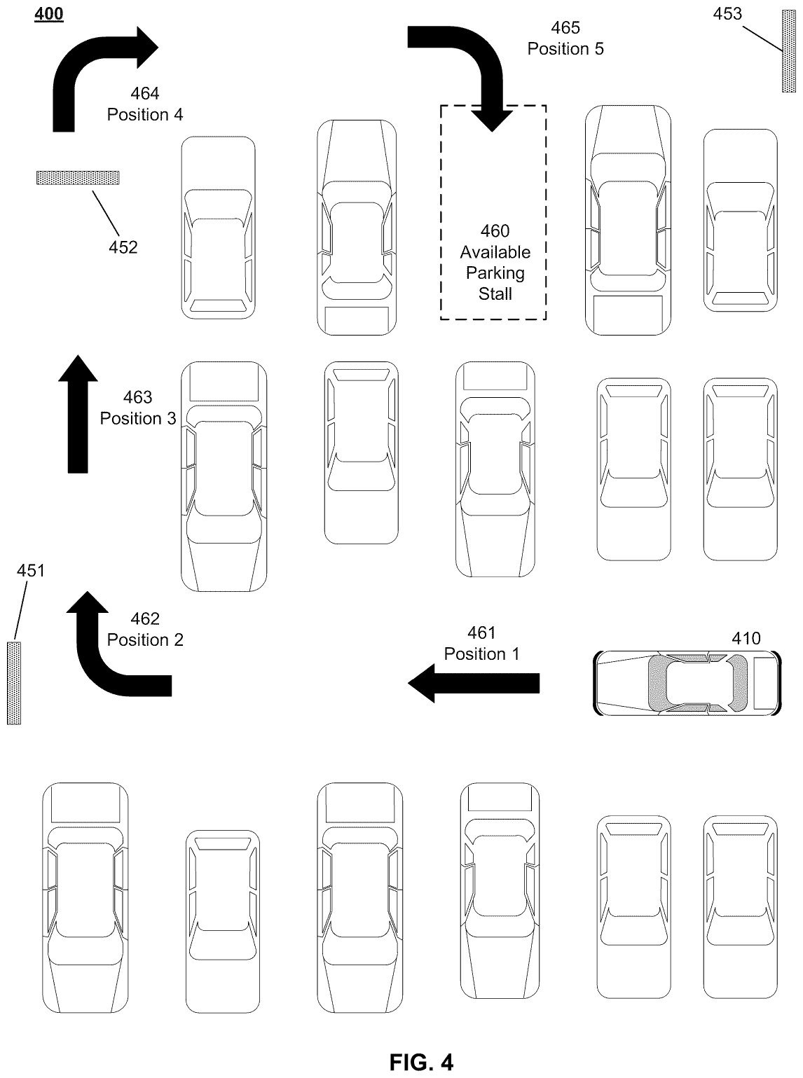

FIG. 4 illustrates an example vehicle navigating a structure implementing a system for providing low connectivity point-based navigation 400, according to various embodiments of the present disclosure. As illustrated, vehicle 410 include user equipment device that captures and processes information from reference point indicator 451, 452, 453 as it navigates within a structure (e.g., a parking structure) to available parking stall 460. Vehicle 410 includes an image capturing device (e.g., a video camera) that is capable of capturing images and/or video in the direction of travel (e.g., forward facing). Additionally, although not illustrated in FIG. 4, vehicle 410 includes a navigational system capable of detecting and processing information related to reference point indicators 451, 452, 453. Such navigational system may be integrated within the vehicle (e.g., a navigation system or an infotainment system) or may be implemented at mobile device associated with a user of vehicle 410 (e.g., a cellular telephone, mobile tablet, or dedicated mobile GPS device).

When vehicle 410 is located at Position 1, vehicle 410 detects reference point indicator 451 and updates its location based on the detection and processing of reference point indicator 451. For example, the camera of vehicle 410 captures an image of reference point indicator 451 and processes that captured information to determine location of vehicle 410 relative to reference point indicator 451. As vehicle 410 travels from Position 1 to Position 2, vehicle 410 may optionally continuously or periodically update its location relative to reference point indicator 451 as it moves from Position 1 to Position 2. Based on the updated locating information determined from detecting reference point indicator 451, the vehicle navigation system of vehicle 410 guides the vehicle to turn right at Position 2.

As vehicle 410 travels from Position 2 to Position 3, vehicle 410 detects reference point indicator 452. Vehicle 410 processes information received by detecting reference point indicator 452 to update its location as it travels from Position 2 to Position 3 and on to Position 4. Once vehicle 410 reaches Position 4, the navigational system within the vehicle 410 guides vehicle 410 to turn right. At Position 4, vehicle 410 detects reference point indicator 453 and processes the information based on the detection of reference point indicator 453 and updates its location as it moves from Position 4 to Position 5. When vehicle 410 reaches Position 5, the vehicle navigation system of vehicle 410 may, in some embodiments, display a notification within the vehicle that it has arrived at available parking stall 460. In some embodiments, available parking stall 460 includes an indicator that it is unoccupied and available for parking. For example, such an indicator may be visual (e.g., a light, sign, or other display indicating that the stall is available), auditory (e.g., an audible sound indicating the stall's location and that it is available), or a signal (e.g., a wireless signal that is detected by vehicle/user equipment device 410 indicating the location and availability of parking stall 460). Additionally, a virtual reality or augmented reality device (whether worn or integrated into the vehicle) may display directions, locations, pathways, or availability.

Although FIG. 4 may be illustrated and described as navigating vehicle 410 within a single floor of a single parking structure to arrive at a single available parking stall 460, the techniques discussed herein are not limited to such embodiments. For example, the reference point navigation system 400 may determine that the user of vehicle 410 desires to park as close as possible to a particular location (e.g., receives a destination input form a user of vehicle 410). In such an example, the parking structure may be used as part of a larger area with multiple stores at various locations relative to the parking structure (e.g., a shopping mall). In such an example, the parking stalls throughout the parking structure may be equipped with sensors to determine whether each parking stall is available. When a particular location is entered, system 400 determines the available parking stall that is closest to the desired location. Once determined, system 400 then implement navigational features to guide vehicle 410 to the identified available parking stall. Additionally, the techniques discussed herein may also be applied to multiple floors and/or multiple parking structures, without departing from the contemplated embodiments.

In another embodiment, system 400 determines an appropriate parking stall for vehicle 410 based on certain criteria. For example, vehicle 410 may have a dedicated parking stall (e.g., a reserved space for that particular user). In such an example, system 400 determines the location of the dedicated parking stall and guides vehicle 410 to the dedicated parking stall. In another example, the user of vehicle 410, or vehicle 410 itself, has certain parking privileges that are not generally available to other vehicles that may use the parking structure. For example, vehicle 410 may be designated as having handicap stall parking privileges. In such an example, system 400 determines the best and/or most appropriate parking stall for vehicle 410. Because vehicle 410 has handicap parking privileges, vehicle 410 navigates vehicle 410 to the most appropriate available handicap parking stall. In other examples vehicle 410 maybe a commercial vehicle or an emergency vehicle that have specialized designated parking areas for such vehicles. Such parking privileges may be automatically converted to system 400 or manually set by a user.

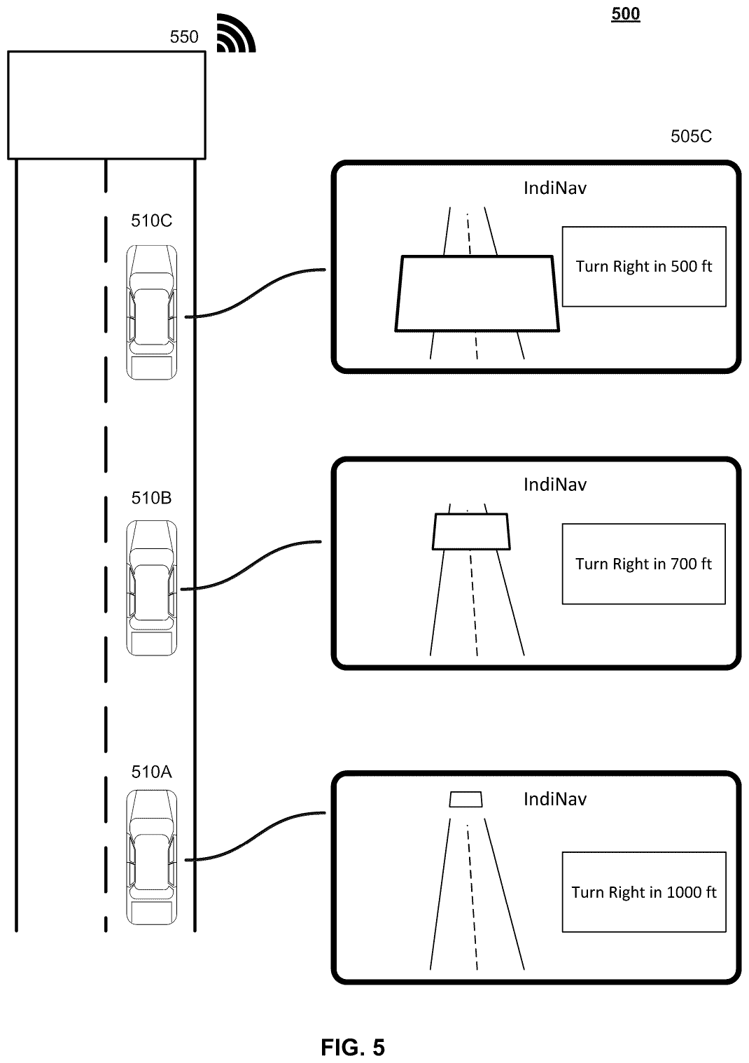

FIG. 5 illustrates example techniques for determining the distance to reference point indicator 550, according to various embodiments for the present disclosure. As illustrated, vehicle 510A-C includes user equipment device 505A-C that displays images captured from a camera in a forward-facing orientation. Reference point indicator 550 is illustrated as a sign that is located above the roadway on which vehicle 510 travels. For simplicity, the size, shape, orientation, and relative distances of the various depicted elements are presented for illustrative purposes only and is not drawn to scale. As vehicle 510 moves closer to reference point indicator 550 in travelling along the roadway, the image of the reference point indicator 550 displayed on user equipment device 505 increases in size. Additionally, although reference point indicator 550 is rectangular in shape, the image displayed representing reference point indicator 550 is in the shape of a quadrilateral due to the offset viewing angle of the camera of vehicle 510 relative to the location and orientation of reference point 550. Although reference point indicator 550 may be illustrated and described as being generally rectangular in shape, reference point indicator 550 may be embodied by any shape without departing from the contemplated embodiments.

In some embodiments, User equipment device 505 accesses a library or database of quadrilateral shapes of different sizes and orientations. Each of the quadrilateral shapes in the database corresponds to known distance and orientation relative to that shape. For example, pre-determined indicator sizes are used to create the database of quadrilateral shapes corresponding to different distances and/or orientations relative to the reference point indicators. A sign, monitor, or other reference point indicator has known dimensions and a known orientation. When the indicator is captured by a camera, computer vision techniques may be applied to extract a quadrilateral shape representing the edges of the indicator. Using the size, shape, orientation, and/or configuration of the extracted quadrilateral, the relative distance and orientation to the indicator is determined. In some embodiments, system 500 includes a library of quadrilaterals in various sizes and shapes, each having associated information that includes a known distance and orientation from a vehicle or other user equipment device. In such embodiments, the extracted quadrilateral from a captured image of an indicator may be compared to those in the library to determine the distance and/or orientation of the vehicle or user equipment device relative to the reference point indicator.

In operation, the camera of vehicle 510A captures an image of reference point indicator 550, which is displayed on user equipment device 505A. The image captured by the camera of vehicle 510A is analyzed to identify the quadrilateral shape corresponding to reference point indicator 550. The image of reference point indicator 550 is analyzed to extract its corresponding quadrilateral shape. That quadrilateral shape is compared to the quadrilateral shapes in the database. Once a matching quadrilateral shape is identified in the database, system 500 determines the XYZ coordinates of vehicle 510A since the location of reference point indicator 550 is known. From this information, system 500 is able to determine the distance from vehicle 510A to reference point indicator 550 based on the identification.

As illustrated, the quadrilateral shape displayed on user equipment device 505A corresponds to a distance of 1000 feet. This process can be continuously or periodically undertaken to update the distance and orientation of vehicle 510 to reference point indicator 550. As illustrated, system 500 determines that vehicle 510B is approximately 700 feet from reference point indicator 550 based on the quadrilateral shape extracted from the image displayed on user equipment device 550B. Similarly, system 500 determines that vehicle 510C is approximately 500 feet from reference point indicator 550 based on the quadrilateral shape extracted from the image displayed on user equipment device 550C.

In some embodiments, the quadrilateral shapes stored in the database need not exactly match an extracted quadrilateral shape of a reference point indicator. In such embodiments, system 500 may estimate the vehicle's 510 location based on multiple stored quadrilateral shapes. For example, system 500 may identify multiple stored quadrilateral shape that are a sufficiently close match to the extracted quadrilateral shape of reference point indicator 550. From the multiple stored quadrilateral shapes, system 500 may extrapolate a distance from reference point indicator 550 based on considering the identified quadrilateral shapes. For example, process 500 they take an average to determine the XYZ coordinates of vehicle 510. In other embodiments, system 500 may use a weighted average to identify XYZ coordinates of vehicle 510.

In other embodiments, system 500 may use other computer vision techniques to determine the relative distance and/or orientation between vehicle 510 and reference point indicator 550. For example, system 500 may use a trained model to detect and track key points of objects such as vehicles, signs, and other reference point indicators. Such a technique may be referred to as pose estimation.

In some embodiments, reference point indicator 550 also includes transceiver or other device capable of transmitting and/or receiving information wirelessly. In such embodiments, reference point indicator 550 may include information that is detected and captured by vehicle 510. For example, reference point indicator 550 may transmit mapping information that system 500 may use to update its location. In other embodiments, reference point indicator 550 may receive information from vehicle 510 and/or user equipment device 505. For example, user equipment device 505 may collect and store information (e.g., mapping information) that is transmitted to reference point indicator 550. That information may then be used to update a database or library either local to, or remote from, reference point indicator 550. In this way, vehicle 510 and/or user equipment device 505 can update mapping and other related information that can be used by other vehicles and/or user equipment devices and/or system 500.

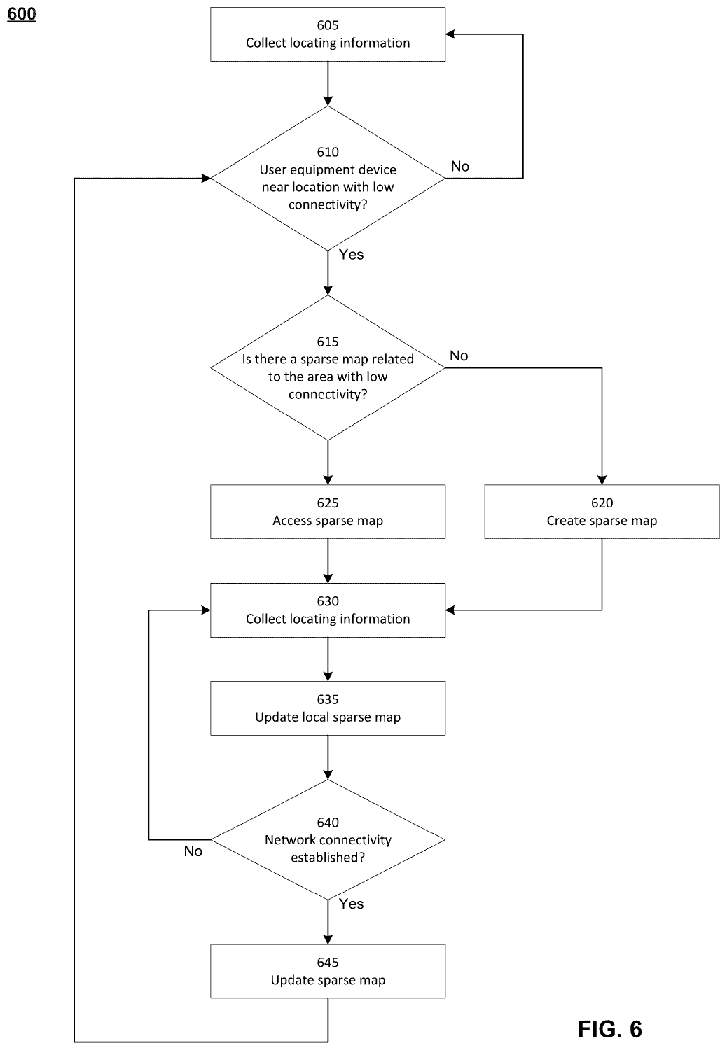

FIG. 6 illustrates an example process for providing low connectivity point-based navigation 600, according to various embodiments of the present disclosure. At 605, process 600 collects locating information. For example, process 600 collects locating information from a GPS or other locating system. Process 600 may optionally consider information from a IMU device.

At 610, process 600 determines whether user equipment device is near a location with low connectivity. In some embodiments, the area may be already known to frequently experience low, diminished, or no connectivity with locating/navigating systems. For example, user equipment devices may have entered the area that includes a parking structure, tunnel, or other structure that inhibits connectivity to GPS locating systems. When those instances of low connectivity are experienced, the user equipment device may store an indication of such connectivity issues along with the location, which is then stored at a database (either local to or remote from the user equipment devices). When a user device subsequently is near the area, system 600 may retrieve the previous indications to determine that the user equipment device is near an area with low connectivity.

In other embodiments, system 600 determines that the user equipment device is near an area with low connectivity by detecting a diminished signal with locating services, for example, by experiencing a diminished signal with GPS locating systems. In the event that process 600 determines that the user equipment device is not near a location with low connectivity, process 600 returns to 605. In the event that process at 100 determines that the user equipment device is near a location with low connectivity, process 600 proceeds to 615.

At 615, process 600 determines whether a sparse map exists related to the area with low connectivity. Process 600 accesses a database to determine whether the database contains a sparse map that is related to the area with low connectivity. In some embodiments, the database is local to the user device. For example, the user equipment device may be embodied by a cellular telephone that includes memory with sparse maps store thereon. In other embodiments, process 600 accesses a database that is remote from the user equipment device. In such embodiments, process 600 may access a remote database through the wireless communication network to determine whether it includes a sparse map that is relevant to the area with low connectivity.

In the event that process 600 determines there is not a sparse map related to the area with low connectivity, process 600 proceeds to 620. In the event that process 600 determines there is a sparse map related to the area with low connectivity, process 600 proceeds to 625.

At 620, process 600 creates a map. In some embodiments, process 600 optionally creates a sparse map when a relevant sparse map is not identified. Process 600 collects locating information from, for example, an IMU device associated with the user equipment device. In such embodiments, process 600 collects the IMU data to determine positioning information of the user equipment device as it moves through the area with low connectivity. In such embodiments, the user equipment device may not have connectivity to a GPS locating system and, in such embodiments, process 600 relies on methodologies that do not require GPS locating information e.g., relying on IMU data or other positioning information. In other embodiments, the user equipment device may have limited or diminished access to a GPS locating system. In such embodiments, process 600 may use information from such a GPS locating system in addition to IMU information to create and/or modify a sparse map. Additionally, process 600 may use information from reference point indicators in creating, augmenting, or updating sparse maps. In some embodiments, the map created at 620 contains more information that is typically associated with a sparse map. For example, process 600 may optionally create a complete map of the area in which the user device is located provided the user equipment device has sufficient resources (e.g., memory, computational capability, etc.) to create and store such a map.

At 625, process 600 access the sparse map. In some embodiments, process 600 access a sparse map that is stored locally. In such embodiments, process 600 accesses a local memory of the user equipment device to determine whether any of the sparse maps located stored thereon relate to the area with low connectivity.

In other embodiments, process 600 accesses sparse maps that are located remotely. In such embodiments, when process 600 determines that a relevant sparse map is available on a remote database or memory, process 600 accesses the sparse map. For example, process 600 downloads the sparse map to the user equipment device. In some embodiments, process 600 downloads the entire sparse map. In other embodiments, process 600 downloads a portion of the sparse map. In yet other embodiments, processed 600 may determine that multiple sparse maps relate to the area with low connectivity and, in such embodiments, process 600 downloads some or all of the sparse maps. Process 600 may access the sparse map via a wireless data network.

At 630, process 600 collects locating information. In some embodiments, process 600 collects locating information from a GPS or other locating system. In embodiments where the user equipment device does not have access to GPS locating information, process 600 may optionally consider information from a IMU device. In some embodiments, process 600 collects locating information from one or more reference point indicators as the user equipment device moves through the area with low GPS connectivity. In such embodiments, process 600 detects the reference point indicators, as discussed herein. In other embodiments, process 600 determines locating information using, e.g., a SLAM system implemented at the user equipment device.

For example, in some embodiments, process 600 detects reference point indicators by capturing such indicators in a photo or video, and extracting relevant information. In such embodiments, the reference point indicator may include a QR code or other visual indicator that, when detected and processed, updates the user equipment device's location in the sparse map. In such an example operation, the user equipment device collects locating information from an IMU that determines the user equipment device's location within the area of low connectivity and process 600 uses that information to determine the device's location within a sparse map. When the user equipment detects a reference point indicator, process 600 determines that the user equipment device must be in a location based on detecting the reference point indicator having a known location and orientation. Process 600 processes the information from the reference point indicator may then update the user equipment device's location within the sparse map based on the reference point indicator and the user equipment device's determined location relative to the reference point indicator. In this way, process 600 corrects for skew or other errors when determining the user equipment device's location in a sparse map while the user equipment device moves through an area with no or low GPS connectivity. Although the reference point indicator may be illustrated and described as including a QR code, any type of reference point indicator capable of conveying locating information to a user equipment device may be implemented without departing from the contemplated embodiments. Such other types of reference point indicators are discussed herein. In some embodiments, process 600 relies exclusively on information from reference point indicators (i.e., without IMU locating information).

In some embodiments, the user equipment device collects information related to, e.g., parking availability. In such an embodiment, the user equipment device detects the presence of parking spaces and determines whether such parking spaces are occupied. For example, the user equipment device may obtain information from, e.g., a LIDAR system that is capable of detecting the presence of a vehicle in a parking stall. As the user equipment device moves through a parking structure, the user equipment device stores information related to the occupancy of the parking stalls. Additionally or alternatively, the user equipment device stores an indication related to the location of the parking stall in which the vehicle parked. Such information may be used to update local or remote versions of applicable maps (e.g., a sparse map that is downloaded by other user equipment devices for future use).

At 635, process 600 optionally updates the sparse map. In some embodiments, process 600 may determine irregularities in the sparse map. For example, process 600 may detect that a particular location has been updated a threshold a number of times with user equipment devices and, based on exceeding that threshold number of times, process 600 determines that the sparse map needs to be updated. In embodiments where the user equipment device is updating a local version of a sparse map, process 600 updates that local version.

At 640, process 600 determines whether network connectivity is established. For example, in embodiments where the user equipment device loses connectivity to a data network when moving in the area of no or low connectivity, process 600 determines whether the user equipment device has reconnected to such a data network. In some embodiments, process 600 continuously or periodically checks whether the user equipment device has access to a data network. In other embodiments, process 600 may receive an indication that connectivity to a data network has been reestablished. In the event that process 600 determines that network connectivity has not been established, process 600 returns to 630. In the event that process 600 determines that network connectivity is established, process 600 proceeds to 645.

At 645, process 600 updates the sparse map. In some embodiments, a local version of a sparse map is updated as the user equipment device moves through the area with no or low connectivity, for example, as discussed with respect to 635. In such embodiments, process 600 may, when network connectivity is reestablished, update the corresponding sparse map stored in a remote database. For example, process 600 may upload the local version of the sparse map to the remote database. Process 600 may then incorporate the updates implemented by the user equipment device into the sparse map stored on the remote database. Such updated sparse map may then be used as a sparse map during subsequent sequent iterations of navigating though areas of low or no connectivity. For example, the same user equipment device that moved through the area of low or no connectivity may then redownload the updated version of the sparse map. In other examples, the updated sparse map may be downloaded by other user equipment devices that move through the same area with low connectivity. In this way, process 600 able to update and refine sparse maps as various user equipment devices move through areas of low connectivity.

In some embodiments, subsequent to 645, process 600 may return to 610, where process 600 determines whether the user equipment device is near an area with low or no connectivity. In other embodiments, subsequent to 645, process 600 ends. In some embodiments, the techniques of process 600 may be implemented in place of, or in conjunction with, the techniques of 210-240, as discussed with respect to FIG. 2.

The features and techniques described with respect to process 600 may be implemented, at least in part, using system 100 and/or process 200, which may be executed at least in part on user equipment device 105, 305, 505, 705, 805a-g, 905a-b, 1005, 1105, and/or at one or more remote servers and/or databases (e.g., server 1150 of FIG. 11), and/or at or distributed across any of one or more other suitable computing devices, in communication over any suitable number and/or types of networks (e.g., the Internet, satellite, cellular). Process 600 may be implemented as a stand-alone application or may be incorporated as part of any suitable application or system. Process 600 may comprise or employ any suitable number of displays; sensors or devices such as those described in FIGS. 1-11; or any other suitable software and/or hardware components; or any combination thereof.

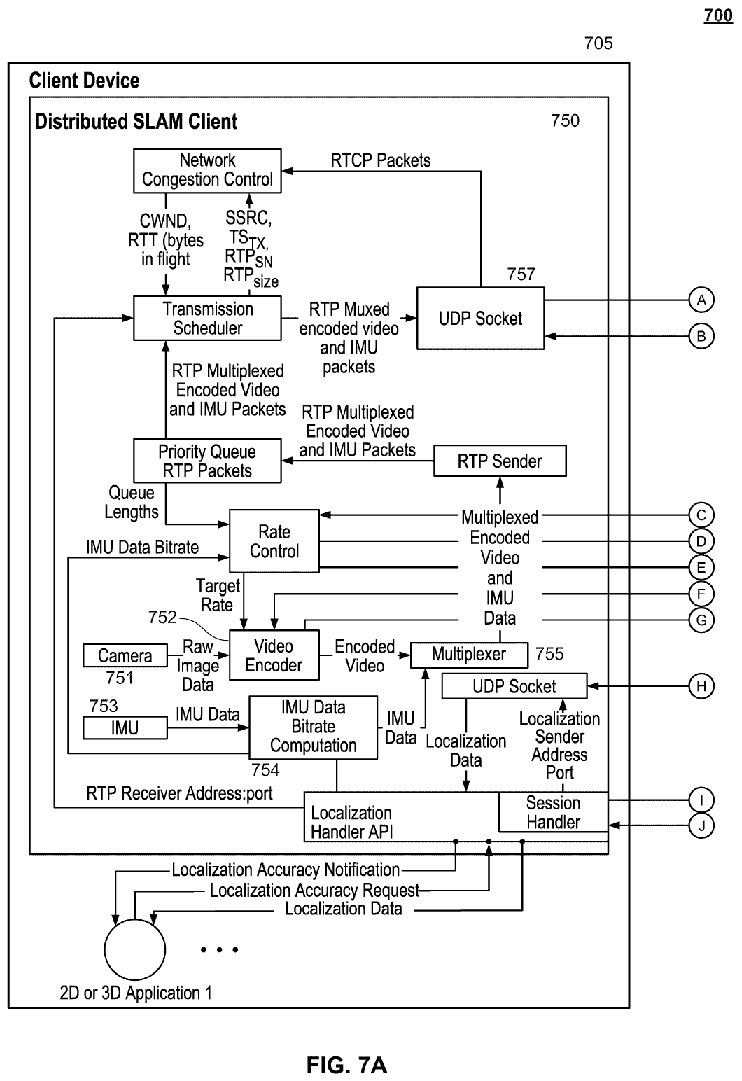

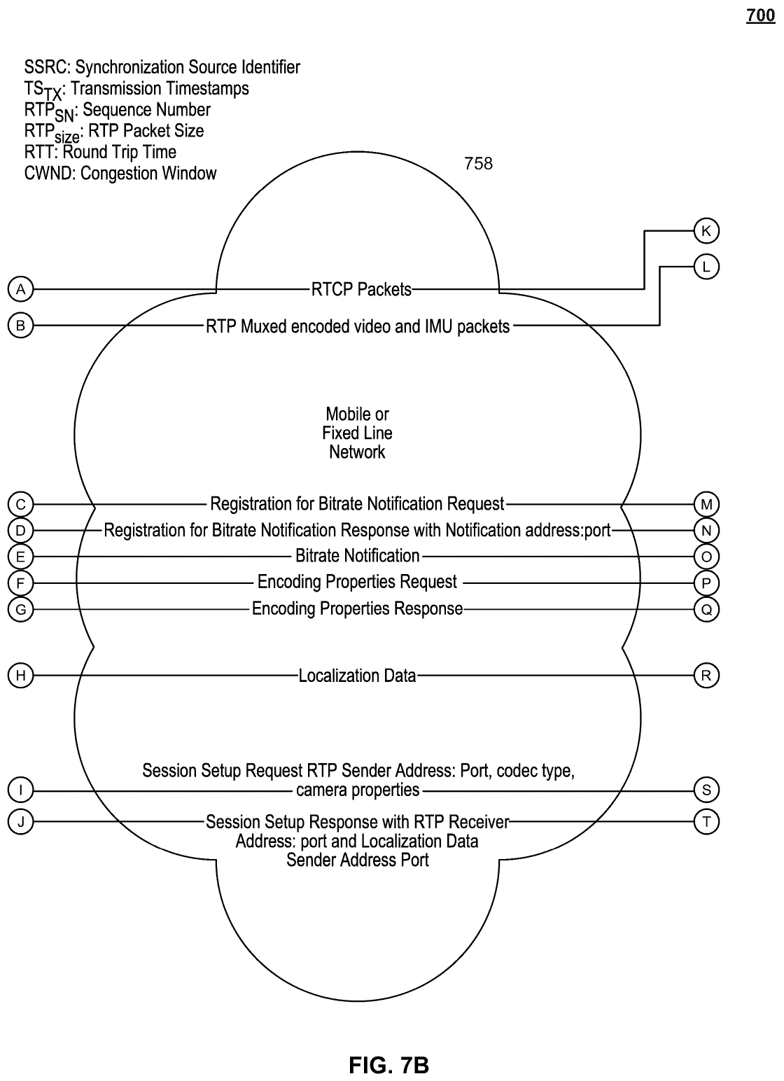

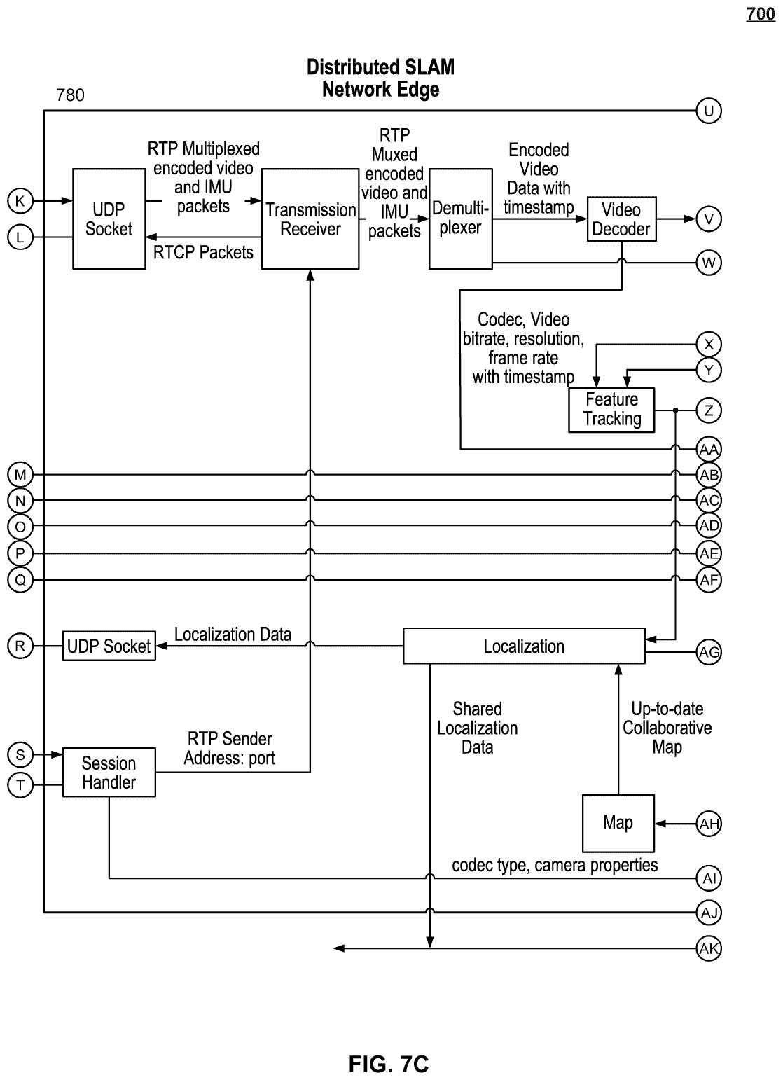

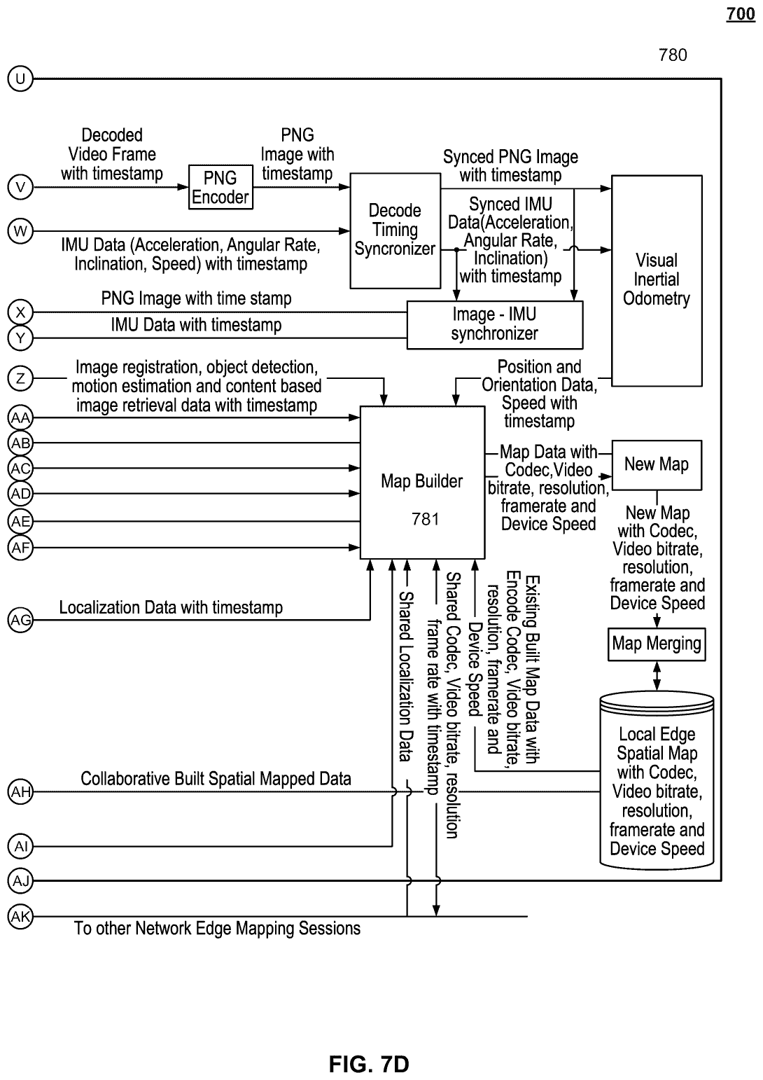

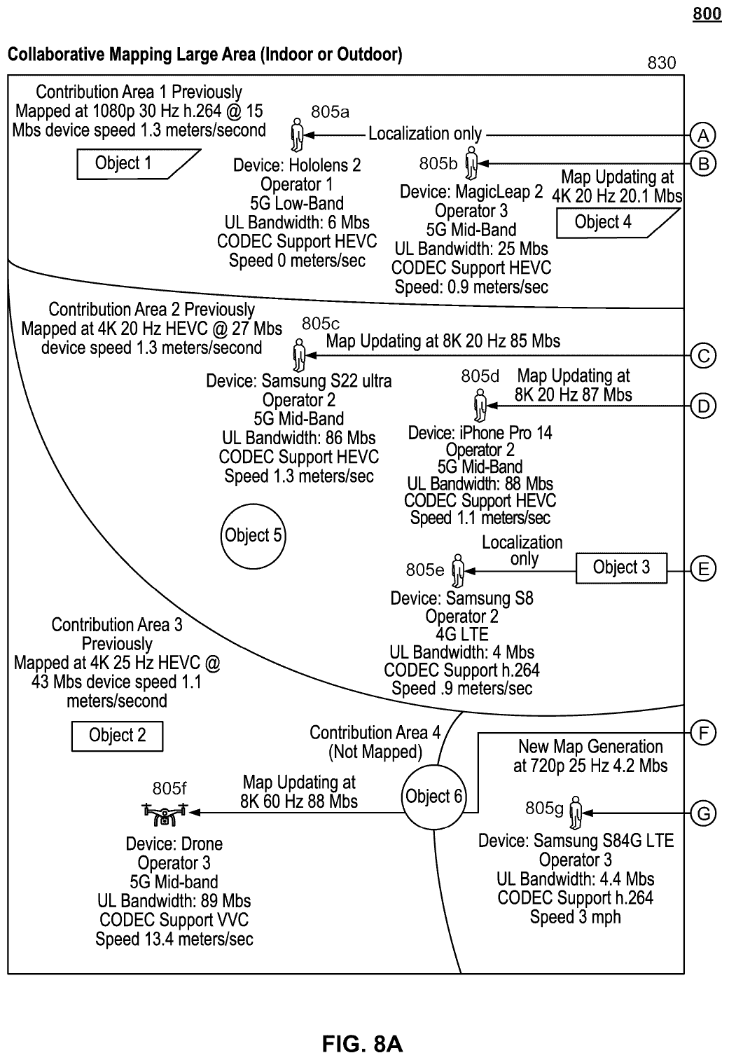

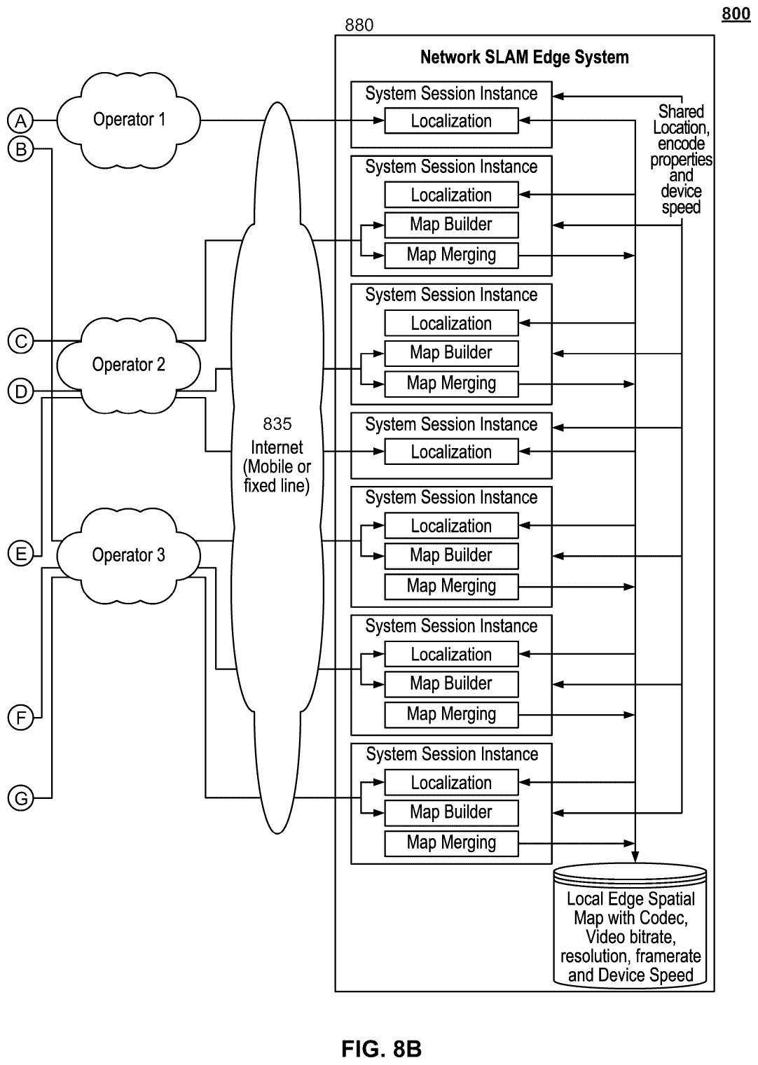

FIGS. 7A-7D illustrate a SLAM-enabled device communicating via exchanges through a data network, with a distributed SLAM network edge service device, server, service, or system 800 shown in FIGS. 8A and 8B, according to various embodiments of the present disclosure. As shown in FIGS. 7A through 7D, the SLAM device 705, such as a user equipment device or other wearable device, smartphone, tablet or other handheld device, laptop computer, industrial robot, vacuum cleaner or other household appliance, drone, automobile or other vehicle, may have a SLAM client 750 that controls a camera 751 for capturing, at a set framerate, a stream of frames as image data that are then transmitted to a video encoder 752 of the SLAM client 750. In addition, the SLAM client 750 may have an inertial measurement unit (IMU) 753, which measures a change in speed or a change in orientation (change in acceleration) of the device and then transmits the IMU data to an IMU data bitrate computation module 754. The IMU data bitrate computation module 754 transmits this data as data packets to a multiplexer 755, which also receives the encoded video data. The multiplexer 755 may also encode the IMU and image data it receives using a selected codec, and then transmits this encoded, multiplexed data to RTP (real end time transport protocol) sender. The example embodiment illustrated in FIG. 7A shows RTP, being used to transmit the data from these sensors (e.g., the camera and the IMU data, as encoded and multiplexed) via a UDP (user datagram protocol) socket 757 through a wireless network 758 to the SLAM network edge service 780. However, it will be understood that other types of processing and other protocols may be used to prepare the data for transmission and to transmit the data. The data may be transmitted via a mobile or fixed line network to the SLAM network edge service shown in FIG. 7B.

The SLAM network edge service 780, illustrated in FIGS. 7C and 7D, may perform localization, according to various embodiments of the present disclosure. In an embodiment, the map of the area of the device is already generated by the map builder module of the SLAM network edge service and stored in a map module 781. However, the map may be generated by another device, for example, one or more other SLAM network edge service devices (e.g., other user equipment devices) and transmitted to the SLAM network edge service 780 and stored there. Data for the map may be generated by the SLAM client 750 and transmitted to the SLAM network edge service 780 or to one or more other SLAM edge service network devices and/or may be generated by and transmitted from other SLAM devices. The generation of the data for the map may be a collaborative process performed by the capturing of data and data transmission by more than one SLAM devices and processed by more than one SLAM network edge services. Some SLAM clients may provide processing, including map building, as part of this process.

Localization accuracy for the SLAM device 705 on the map, as needed for the SLAM device 705, may be provided by the distributed SLAM network edge service 780 illustrated in FIG. 7C-7D, based on the image data received from the SLAM client 750 of the SLAM device 705 and based on the IMU data received from the SLAM client 750. The SLAM network edge service 780 may provide a level of localization accuracy needed at the moment for the SLAM device 705, as discussed herein. The SLAM network edge service 780 may be a base station for a mobile telephony system or other network, may be stationary or mobile, airborne, on the ground or water, or may itself be a SLAM device 705 that moves autonomously and needs to be localized on the map.

FIGS. 8A-8B illustrate an example of cloud-based SLAM system architecture where the maps are built or updated in real-time or near-real-time that relate to an area 830, according to various embodiments of the present disclosure. In operation (and as illustrated), the quality of the map may be directly related to the encoded bitrate, resolution, and framerate in which the map was built. Such qualities may be stored with the map data. When the map is updated (e.g., based on the device sensors), using processing capabilities and bandwidth, the user equipment device (e.g., any of the devices 805a-805g illustrated in FIG. 8A) may receive a notification to switch from localization only mode to map building mode. Alternatively, the user equipment device 805a-805g may switch from localization mode to map building mode when it determines that a sparse map is not available for an area with limited GPS connectivity.

In some embodiments, several SLAM-enabled devices 805a-805g with sensors capture images, which may comprise image data of various parameters. Each SLAM-enabled device 805a-805g transmits the image, date, and other information it captures via a data network, such as the Internet or other wireless network 830, to the SLAM edge service network 880 of SLAM processors, such as the SLAM edge service processor. An example of a SLAM network edge service processor is illustrated in FIG. 8B. The SLAM network edge service processor 880 is illustrated as maintaining system sessions with several SLAM enabled devices, and as maintaining a local edge service, spatial (sparse) map of the device region 830, which may also maintain a record of the resolution, framerate, and/or other parameters as discussed herein. Such can be undertaken for each set of images or other data captured, including the codec used and the speed with which the SLAM-enabled device 805a-805g was traveling at the time of image capture, the acceleration and/or orientation of the device, and any other locating information. The bit rate of transmission of the image data to the SLAM network edge service 880 may determine how much data can be throughput using the encoding protocol. Some more modern techniques for example, because of the efficiency in which they encode and compress image data, may require a lower bit rate for transmitting the same amount of raw image data.

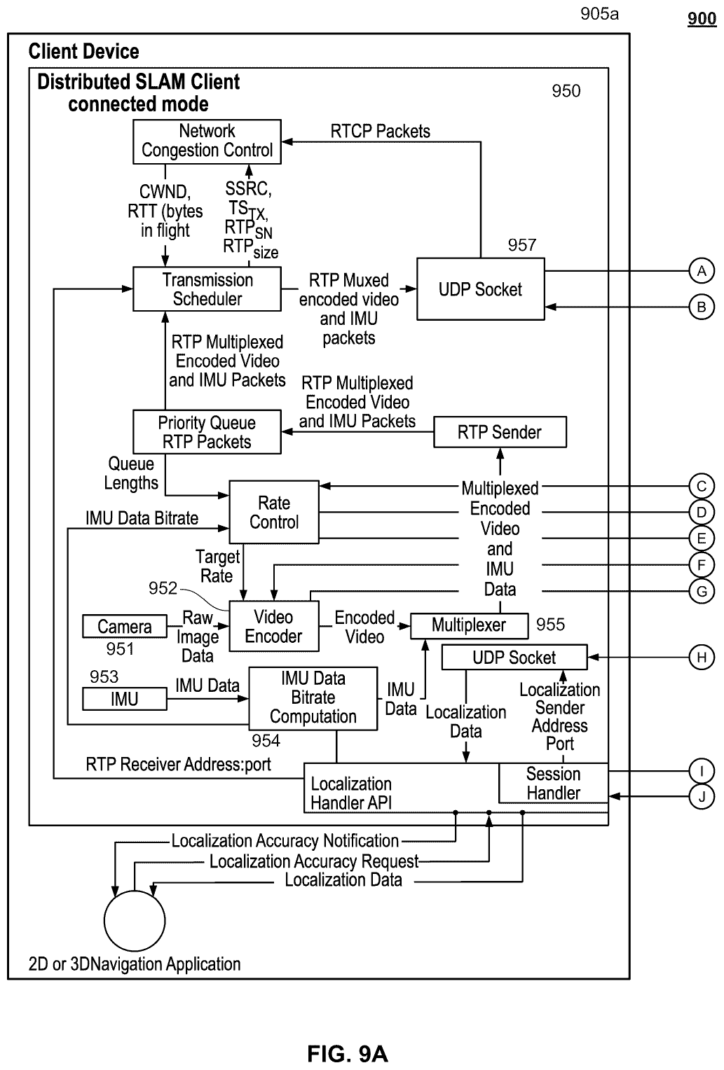

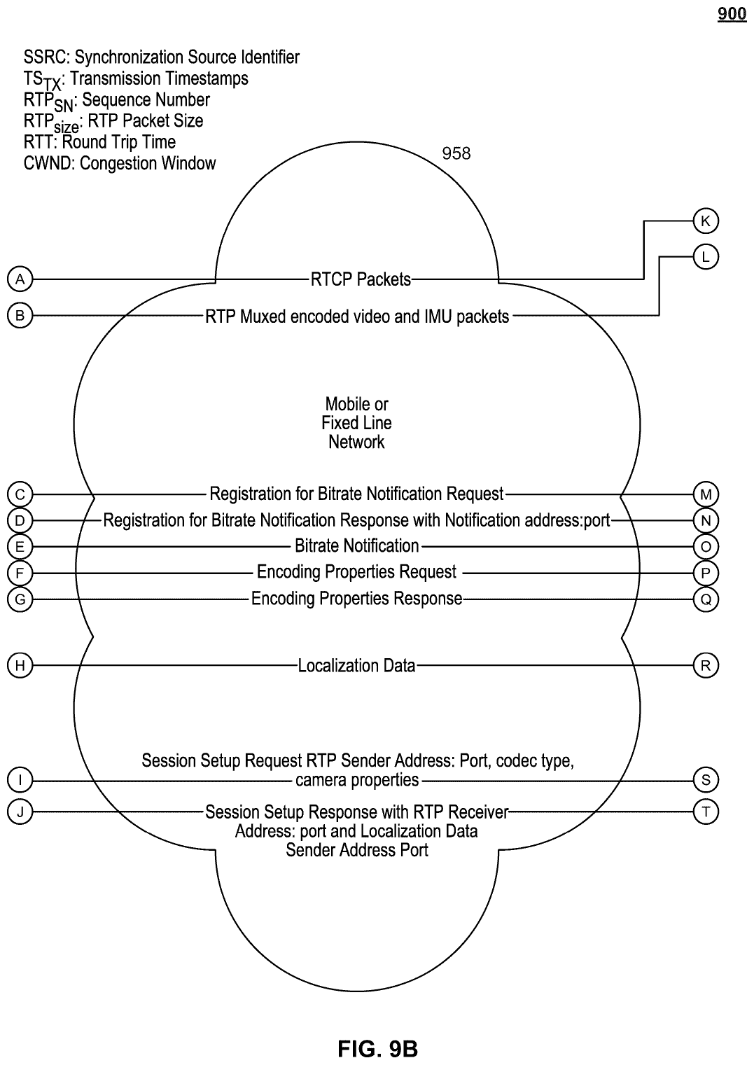

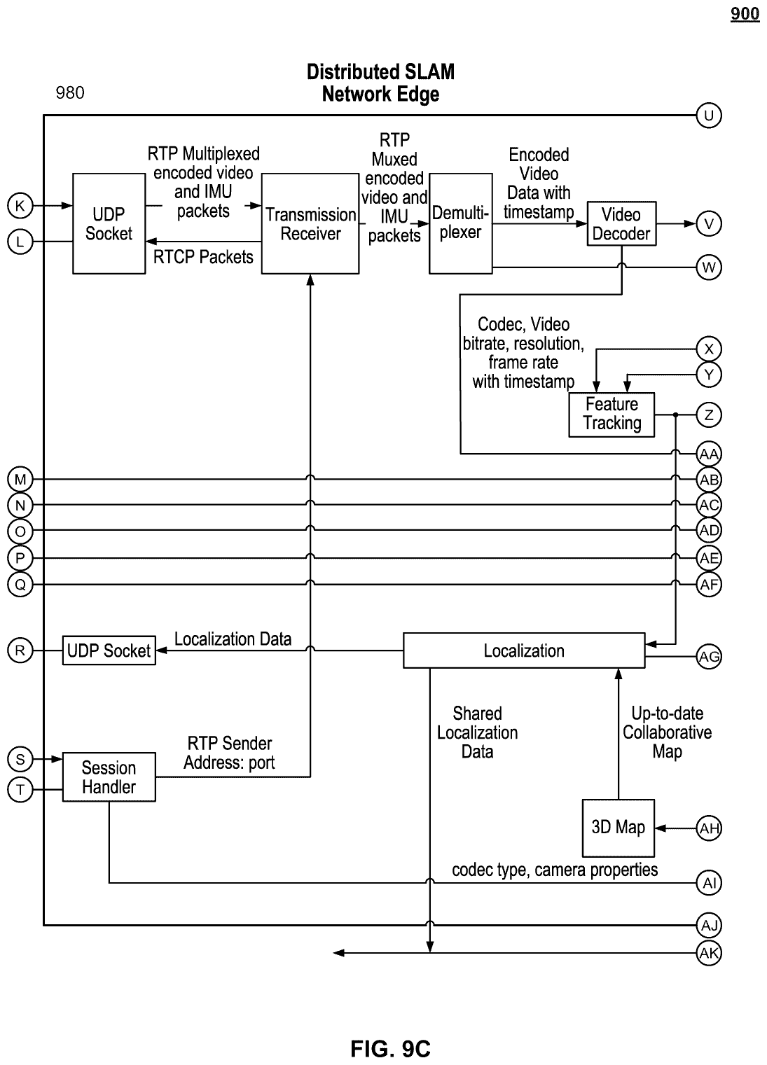

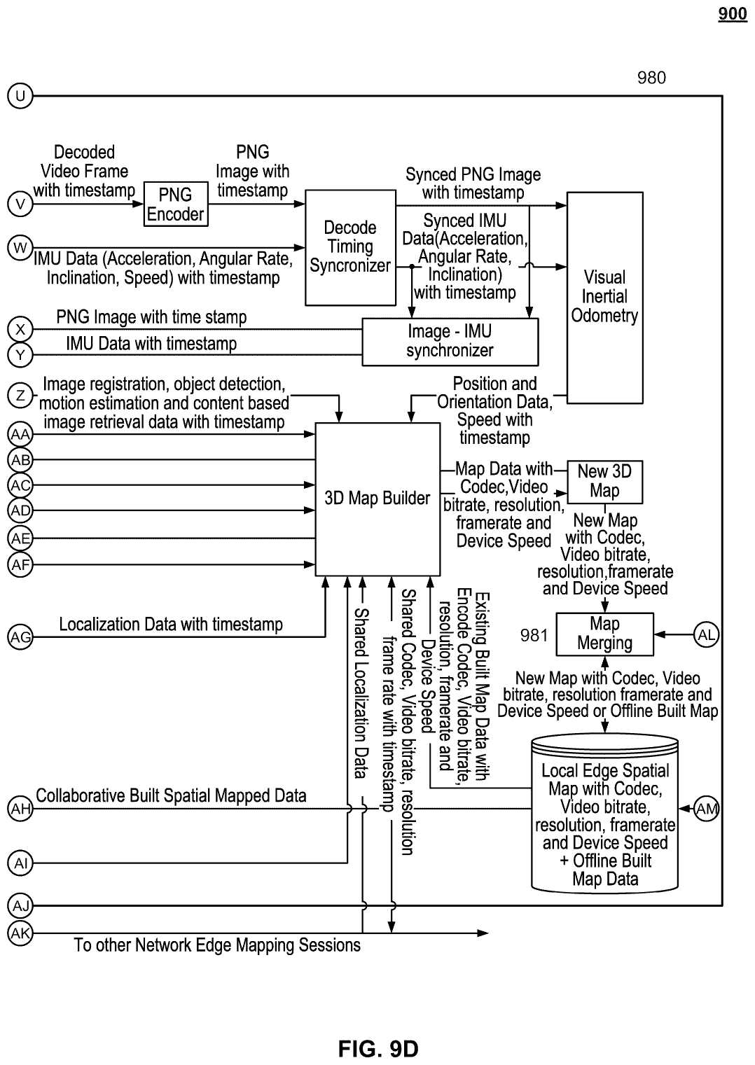

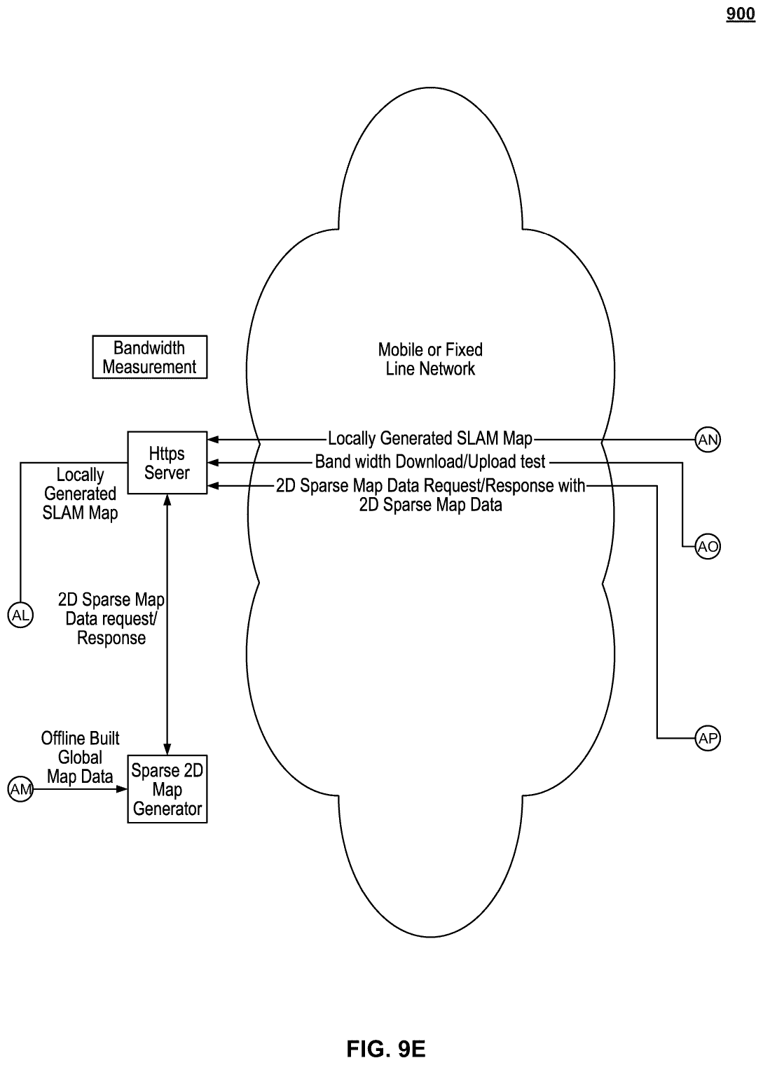

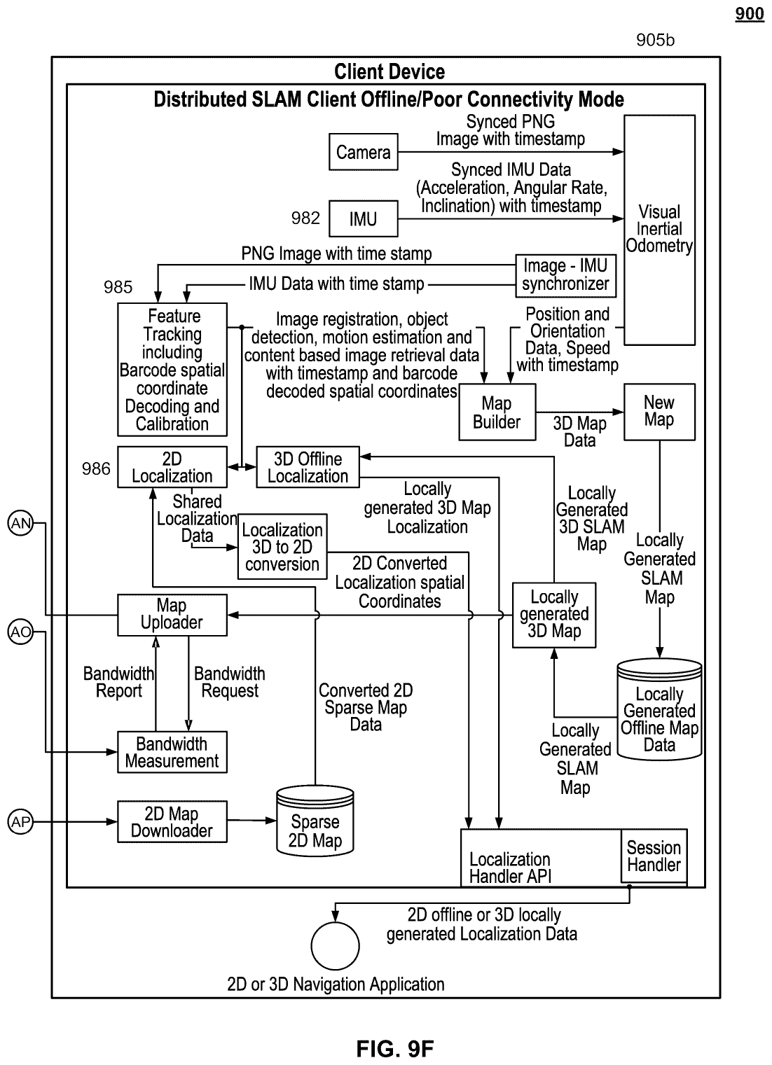

FIGS. 9A-9F illustrate system 900 to support the embodiments of the present disclosure. In addition to the techniques discussed herein (e.g., those discussed with respect to FIG. 7), system 900 may additionally generate a map locally on the user equipment device using the same map building system implemented locally on the user equipment device (e.g., client device 905) when the connection quality to a GPS system is poor or there is no connection where cloud-based map building/updating and localization is not functional. While the network QoS may not support cloud-based map building, updating, and localization, user equipment device 905a, 905b may generate the 2D or 3D map (including a sparse map) and store such a map locally on the user equipment device 905b. When the connection QoS is sufficiently strong (e.g., as determined by a bandwidth tests) to support a map upload, the locally generated map may be uploaded to the cloud-based mapping system 980 and the Map Merging function may merge the map data (e.g., at map merging 981), where applicable, into one or more global maps. The previously undefined areas of the map, since such were generated offline, will be identified as areas in the map with no connectivity. Such is an example of how system 900 may identify areas with poor or no connectivity. Additional subsystems may be added to system 900 to support sparse map generation where the number of feature points (e.g., objects with stored spatial coordinates) will be minimal or not present. In some embodiments, only the x- and z-axis coordinates are needed for 2D navigation. In such 2D implementations, y-axis information (e.g., height) may be determined by data from the IMU (e.g., IMU 982). Each floor in a multistory structure may have its own map data that may be loaded based on the height estimation of IMU 982 when user equipment device 905b moves in the y-axis (e.g., up and down), resulting in a different map being accessed. In some embodiments, the maps are accessed when sufficient connectivity exists. In some embodiments, multiple maps in the proximity may be loaded at once based on the network QoS stored with the map data and the determination that user equipment device 905b is moving into an area of low/poor connectivity (e.g., area 830 as described with respect to FIG. 8). Such a downloaded 2D map may be used by the local SLAM processing for navigation. In some embodiments, since the sparse map will contain minimal to no feature points, the Feature Tracking subsystem 985 may leverage spatial coordinates embedded in QR codes for IMU recalibration. A new 2D localization subsystem 986 may be included in the local system for providing navigational directions leveraging only the x-and z-axis. Such a technique will provide localization and navigation in the areas with limited to no connectivity. Additionally, in some embodiments, 3D navigation may also be provided based on the locally generated offline map. In other embodiments, the offline 2D navigation of using the sparse 2D map downloaded will be sufficient.

As illustrated in FIGS. 9A-9F, a SLAM-enabled device communicates via exchanges through a data network, with a distributed SLAM network edge service device, server, service, or system 800 shown in FIGS. 8A and 8B, according to various embodiments of the present disclosure. Similar to the techniques illustrated and described with respect to FIGS. 7A-7D, the SLAM device, such as a user equipment device 905a, 905b or other wearable device, smartphone, tablet or other handheld device, laptop computer, industrial robot, industrial equipment, vacuum cleaner or other household appliance, drone, automobile or other vehicle, may have a SLAM client 950 that controls a camera 951 for capturing, at a set framerate, a stream of frames as image data that are then transmitted to a video encoder 952 of the SLAM client 750. In addition, the SLAM client 750 may have an inertial measurement unit (IMU) 953, which measures a change in speed or a change in orientation (change in acceleration) of the device 905a, 905b and then transmits the IMU data to an IMU data bitrate computation module 954. The IMU data bitrate computation module 954 transmits this data as data packets to a multiplexer 955, which also receives the encoded video data. The multiplexer 955 may also encode the IMU and image data it receives using a selected codec, and then transmits this encoded, multiplexed data to RTP (real end time transport protocol) sender. The example embodiment illustrated in FIGS. 9A-9F shows RTP, being used to transmit the data from these sensors (e.g., the camera 951 and the IMU 953 data, as encoded and multiplexed) via a UDP (user datagram protocol) socket 957 through a wireless network 958 to the SLAM network edge service 980. However, it will be understood that other types of processing and other protocols may be used to prepare the data for transmission and to transmit the data. The data may be transmitted via a mobile or fixed line network to the SLAM network edge service shown in FIGS. 9B, 9E.

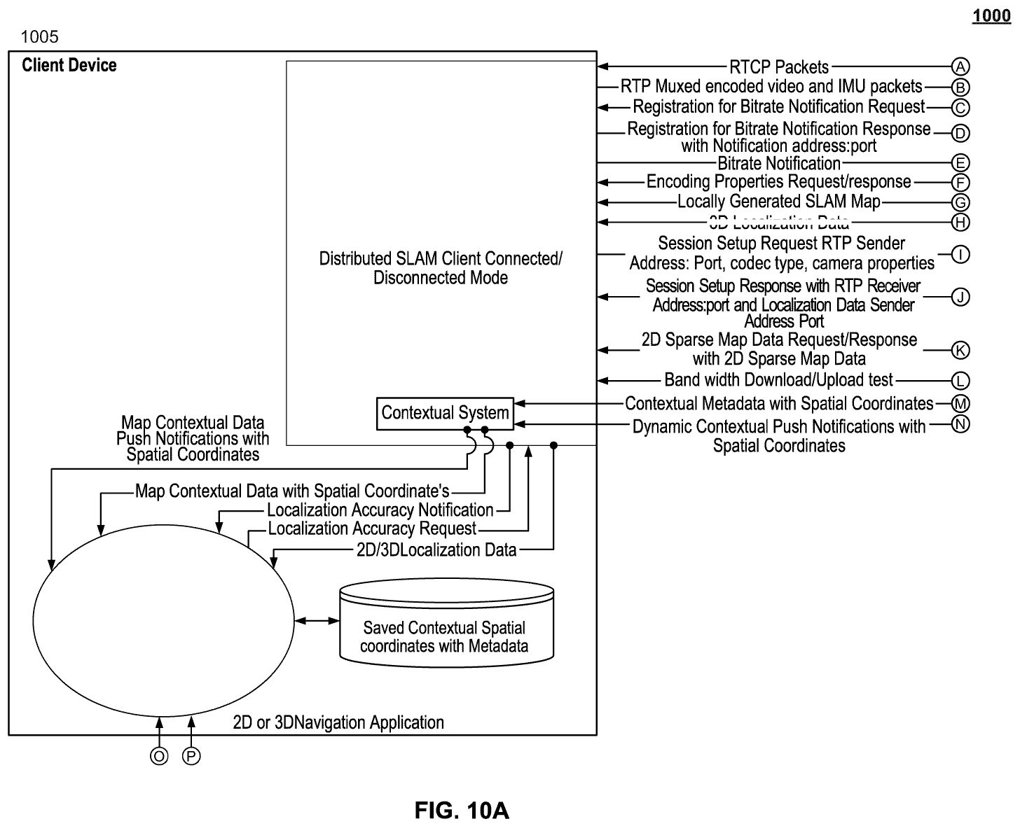

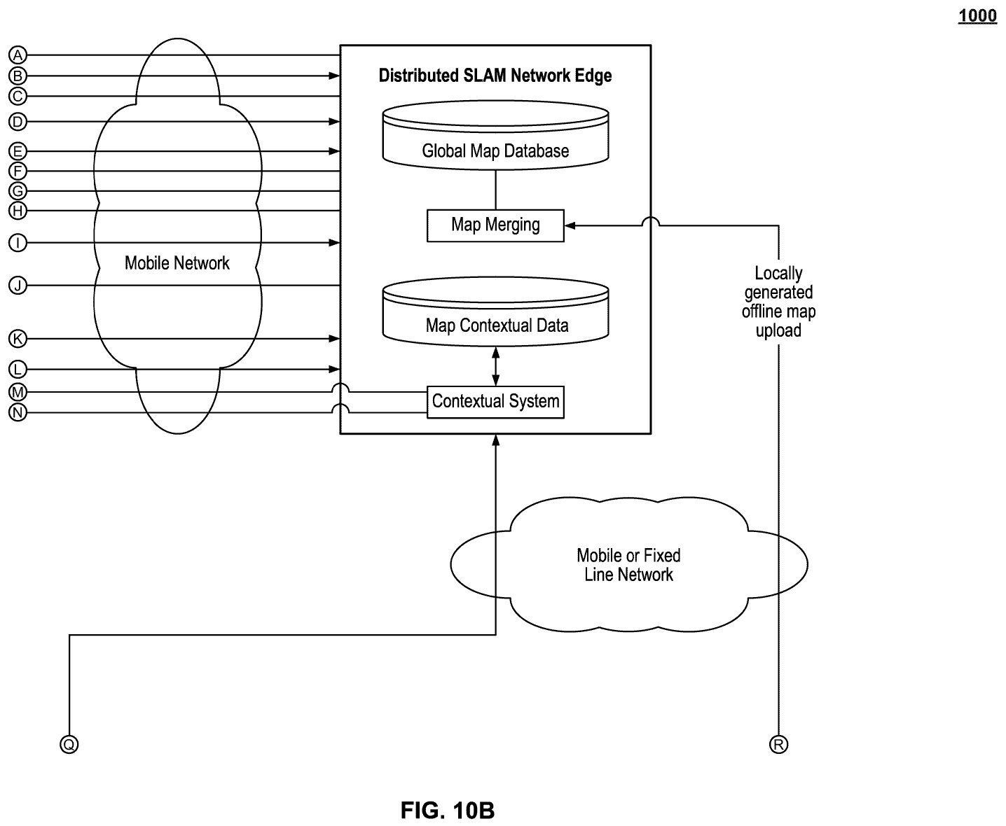

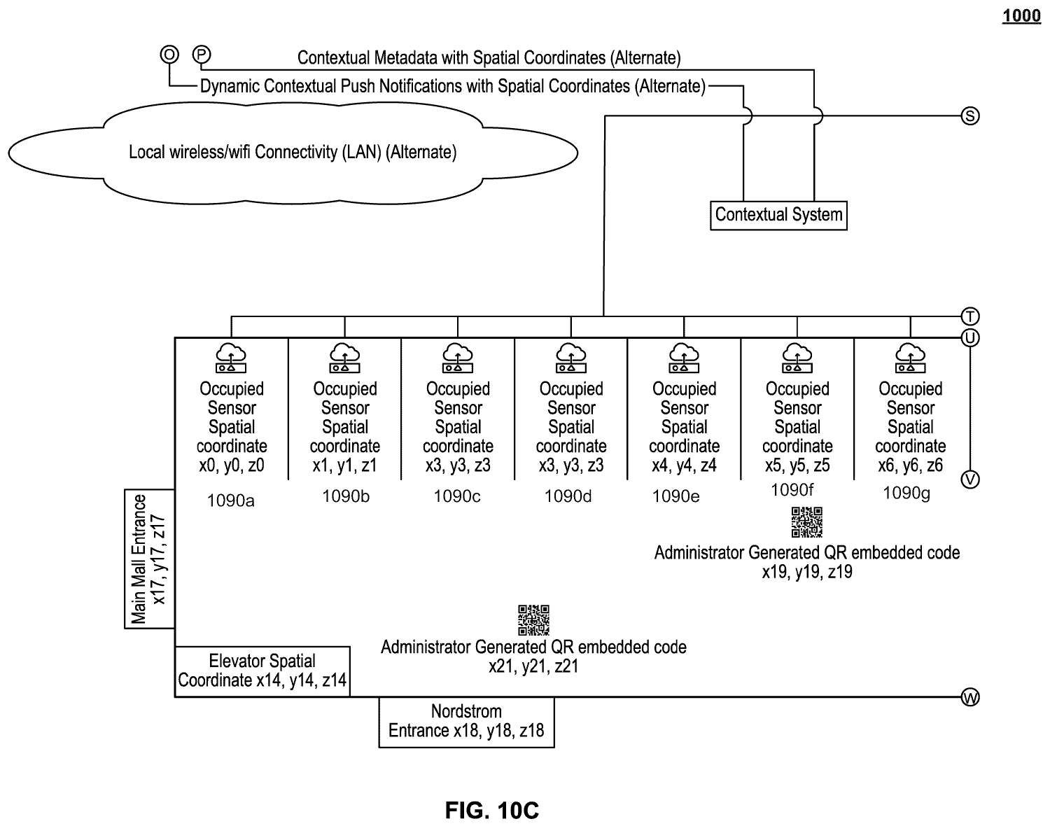

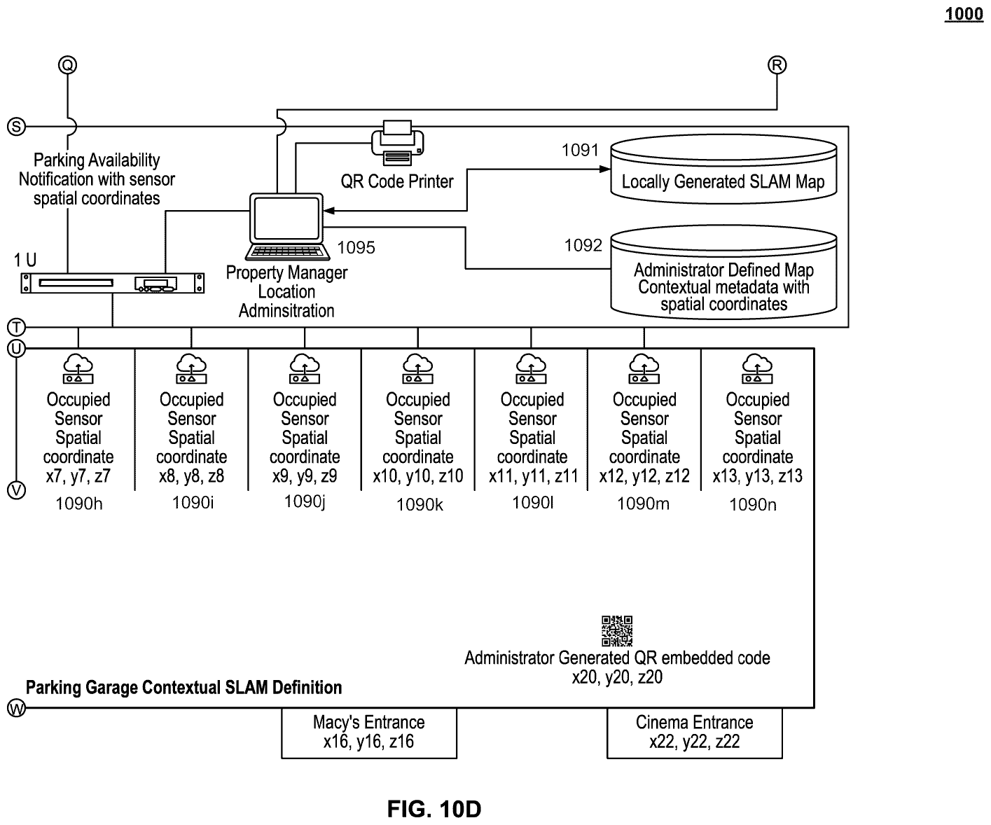

The techniques illustrated and described with respect to 9A-9F additionally include the distributed SLAM client in offline or poor connectivity mode. In some embodiments, the offline SLAM client device collects locating information as it moves though areas with low or no connectivity, for example, those discussed with respect to 215-240, as discussed with respect to FIG. 2 and those discussed with respect to 610-645, as discussed with respect to FIG. 6 FIGS. 10A through 10D illustrates an architecture of system 1000 with contextual metadata added to a map, according to various embodiments of the present disclosure. In some embodiments, the features and techniques illustrated are implemented in a parking structure that includes parking sensors (e.g., sensors 1090a-m) associated with each parking stall. System 1000 may use a mobile SLAM offline mapping system (e.g., 905b as discussed with respect to FIG. 9) compatible with the cloud-based system to create a SLAM map of the entire parking structure. Such a cloud-based SLAM system may merge the locally created map(s) data with the global map(s) data. System 1000 assigns parking sensors 1090a-m to spatial coordinates of a parking space and stores the contextual data to the mapped area for each stall (e.g., in databases 1091, 1092). In some embodiments, each stall includes a sensor 1090a-n with a unique sensor ID. Such map data may be viewed in a visual management system, e.g., on a computer, AR/XR device, or other mobile device (e.g., user equipment 105, 305, 505, 705, 805a-g, 905a-b, 1005, 1105). Contextual metadata may be assigned to the spatial coordinates within the map at known areas or points of interest. For example, the stalls may be certain information associated therewith, such as the map name parking level (1,2 3), elevator, store name, main mall, points in ingress or egress, emergency routes, emergency services, and entrances and/or exits to certain stores or locations within the map area. In some embodiments, a mobile XR mapping device or computer system may also save locations for areas automatically identified. In such embodiments, QR codes are generated and positioned at specific locations within the offline mapped space. In placing such QR codes in the mapped area, an administrator (e.g., property manager location administration 1095) can place QR codes within the mapped area. For example, the administrator's XR device may access a map stored locally and the XR device can guide the administrator to the exact locations to place the reference point indicator (e.g., QR codes with encoded spatial coordinates) to be used for recalibration of IMU skew.

In some embodiments, the Navigation application (e.g., as implemented at client device 1005) may also store additional information on the device for walking directions to/from parking location, and to/from each entrance. System 1000 may be configured to implement both high QoS connected environments or, alternatively, no connection/offline environments. In addition to a parking stall occupy sensor 1090a-m, the SLAM map can also be updated by devices based on the objects/vehicles occupying areas within the parking structure and uploading the offline map when sufficient bandwidth is available. Such techniques may be combined with other features and techniques illustrated and discussed herein.

In some embodiments, the availability of the parking stall may be updated based on information from the user client device. For example, following successful parking, the system updates the parking lot's database to indicate the space's occupancy using various methods, including photoelectric sensors or the driver's internet-connected mobile device. Furthermore, if the parking structure has network (e.g., Wi-Fi or UWB) connectivity or vehicles can be connected via, e.g., V2V communication, the vehicle's location can be updated at correction points or more frequently, ensuring more precise navigation.

In another example embodiment of the present disclosure and with reference to FIG. 11, system 1100 (which may correspond to system 100 or any other suitable system described herein) includes user equipment 1105, mapping service 1140, server 1150, which are able to communicate with one another using communication network 1130. In some embodiments, user equipment 1105 may be embodied by a vehicle (e.g., vehicle 1110) or a device/component of vehicle 1110. In some embodiments, server 1150 includes control circuitry 1152, IO path 1154, and storage 1156. In some embodiments, user equipment 1105 may additionally include control circuitry 1152a, IO path 1154a, and storage 1156a. FIG. 11 illustrates generalized embodiments of an illustrative device, e.g., user equipment 105, 305, 505, 705, 805a-g, 905a-b, 1005, 1105. For example, user equipment 1105 may be a smartphone device, a tablet, a computer, a remote control, a mobile navigation device, an infotainment or navigation system integrated into or associated with vehicle 1110, or any other device capable of implementing the techniques of the present disclosure. In other embodiments, user equipment 1105 is navigational equipment installed or included in a vehicle (e.g., vehicle 110, 410, 510, 1110). In some embodiments, server 1150 may include one or more circuit boards. In some embodiments, the circuit boards may include control circuitry (e.g., control circuitry 1152) and storage (e.g., RAM, ROM, Hard Disk, Removable Disk, etc.) (e.g., storage 1156). In some embodiments, circuit boards may include an input/output path (e.g., I/O Path 1154). In some embodiments, user equipment 1105 may receive content and data via input/output (hereinafter “I/O”) path 1154. I/O path 1154 may provide content (e.g., mapping data/information available over a local area network (LAN) or wide area network (WAN), and/or other content) and data to control circuitry 1152 and storage 1156. Control circuitry 1152 may be used to send and receive commands, requests, and other suitable data using I/O path 1154. I/O path 1154 may connect control circuitry 1152 to one or more communications paths (described below). I/O functions may be provided by one or more of these communications paths but are shown as a single path in FIG. 11 to avoid overcomplicating the drawing.

Control circuitry 1152 should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate units, for example, multiple of the same type of processing units (e.g., two Intel Core i7 processors) or multiple different processors (e.g., an Intel Core i5 processor and an Intel Core i7 processor). In some embodiments, control circuitry 1152 executes instructions for an application stored in memory (e.g., storage 1156). Specifically, control circuitry 1152 may be instructed by the application to perform the functions discussed herein. For example, the application may provide instructions to control circuitry 1152 to generate the navigational information. In some implementations, any action performed by control circuitry 1152 may be based on instructions received from the application.

In client server-based embodiments, control circuitry 1152 may include communications circuitry suitable for communicating with a user equipment (e.g., user equipment 1105) or other networks or servers. The instructions for carrying out the functionality discussed herein may be stored on the server (e.g., server 1150). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry (e.g., I/O Path 1154). Such communications may involve the Internet or any other suitable communications networks or paths (e.g., I/O Path 1154). In addition, communications circuitry may include circuitry that enables peer-to-peer communication of user equipment devices, or communication of user equipment devices in locations remote from each other (described in more detail herein).

Memory may be an electronic storage device provided as storage 1156 that is part of control circuitry 1152. As referred to herein, the phrase “electronic storage device” or “storage device” should be understood to mean any device for storing electronic data, computer software, or firmware, such as random-access memory, read-only memory, hard drives, non-transitory computer readable medium, or any other suitable fixed or removable storage devices, and/or any combination of the same. Storage 1156 may be used to store various types of content, navigation data, and instructions for executing content access applications. Nonvolatile memory may also be used (e.g., to launch a boot-up routine and other instructions).

Control circuitry 1152 may include video-generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 1152 may also include scaler circuitry for upconverting and downconverting content into the preferred output format of the user equipment 1105. Circuitry 1152 may also include digital-to-analog converter circuitry and analog-to-digital converter circuitry for converting between digital and analog signals. The tuning and encoding circuitry may also be used to receive guidance data. The circuitry described herein, including for example, the tuning, video-generating, encoding, decoding, encrypting, decrypting, scaler, navigating, and analog/digital circuitry, may be implemented using software running on one or more general purpose or specialized processors. If storage 1156 is provided as a separate device from user equipment 1105, the mapping and encoding circuitry may be associated with storage 1156.

A user may send instructions to control circuitry 1152 using a user input interface that is part of or associated with user equipment (e.g., user equipment 105, 305, 505, 705, 805a-g, 905a-b, 1005, 1105). User input interface may be any suitable user interface, such as a remote control, mouse, trackball, keypad, keyboard, touchscreen, touchpad, stylus input, joystick, voice recognition interface, or other user input interfaces. The user interface may be provided as a stand-alone device or integrated with other elements of each one of user equipment 1105 and system 1100. For example, the user interface may be a touchscreen or touch-sensitive display. In such circumstances, user equipment 1105 may be integrated with or combined with the user interface.

Mapping service 1100 may be implemented using any suitable architecture. For example, mapping service 1100 may be a stand-alone application wholly implemented on user equipment 1105. In such an approach, instructions for the application are stored locally (e.g., as discussed with respect to FIGS. 2-3 and 6-9), and data for use by the application is downloaded on a periodic basis (e.g., from an out-of-band feed, from an Internet resource, or using another suitable approach). Control circuitry at user equipment (e.g., 1105) retrieves instructions of the application from storage (e.g., storage 1156) and process the instructions to generate any of the displays discussed herein. Based on the processed instructions, control circuitry may determine what action to perform when input is received from input interface.

In an embodiment, user equipment 1105 requests navigation from mapping service 1140 using communication network 1130. In such an embodiment, user equipment 1105 can request turn-by-turn navigation. In an example embodiment, user equipment device 1105 requests navigation from mapping service 1140 using communication network 1130. When user equipment device enters or is near an area with low or no connectivity to GPS system 1120, user equipment device 1105 requests a sparse map from mapping service 1140 and/or server 1150. In such an embodiment, user equipment 1105 requests navigational directions to be implemented from a starting location to a final destination. Such final destinations include a parking stall, a location with the user navigates to (e.g., a store or other location), an entrance or exit to a structure, or any other location to which the user equipment may navigate. User equipment 1105 displays a user interface that displays various information, for example, directions, one or more destinations, points of interest, traffic information, weather information, identified traffic events, or any other information that may impact user equipment's 1105 journey from the starting location to the final destination. Additionally, the user interface displayed on user equipment 1105 may also provide user selectable inputs that enable user interaction with mapping system 1100. In an embodiment where user equipment 1105 navigates using a sparse map, user equipment 1105 may display an indication that the sparse map is being used (e.g., displaying an indication that user equipment device is no longer using traditional GPS navigation). In such an embodiment, user equipment device 1105 communicates with mapping service 1140 using communication network 1130 to send and receive navigational information displayed on user equipment 1105 once connection is reestablished.

In another example embodiment, user equipment 1105 stores information. For example, user equipment 1105 stores navigational routes, starting locations, final destinations, points of interest, user preferences, user selections, or other information related to or collected during navigation. For example, locating information that user equipment device 1105 collects (e.g., from an IMU, or related to reference point indicators). Alternatively or in addition, some or all of the computational resources used by user equipment 1105 are implemented at server 1150. For example, information stored at user equipment device 1105 can be stored at server 1150, for example, at storage 1156. Additionally, some are all of the methods or processes implemented by user equipment 1105 are implemented at server 1150, for example, at control circuitry 1152. In such an embodiment, information can be communicated between server 1150 and user equipment 1105 over communication network 1130 and using, for example, IO path 1154. In some embodiments, mapping service 1140 is implemented at server 1150. In such an example implementation where the user equipment device is navigating within a building or other structure where cellular and GPS connectivity is diminished or interrupted, user equipment device 1105 may communicate via an alternative network (e.g., internet connected via Wi-Fi or other communications network) to send and receive information between user equipment device 1105, GPS system 1120, mapping service 1140, and/or server 1150.

Although certain features and technique of the present disclosure are illustrated and described implemented in certain embodiments, the techniques and features of the present disclosure may be implemented to a variety of situations. For example, techniques of the present disclosure may be applied navigating in indoor shopping center. In such embodiments, the reference point indicators may be embodied by monitors that dynamically change what is displayed. For example, such monitors may actively display QR codes with XYZ coordinates or URIs, or images with URIs or XYZ coordinates embedded within. In embodiments where URIs are used, they may direct the user equipment device to a web page detailing exact XYZ coordinates captured by cameras focused on each monitor. Such embodiments allow creation of more complex map.

Additionally, such monitors may offer personalized navigation solutions. In such embodiments, such monitors may communicate with the shopping center's guidance system to provide individual directions for movement within the shopping center, tailoring the experience to each user's location and intended destination. Such interaction enables a seamless authentication process to occur when each reference point indicator is detected, allowing the shopping center's guidance and navigation systems to pinpoint the exact location of each visitor or the motorized shopping cart traversing the shopping center's area.

In another example, techniques of the present disclosure may be applied devices within a warehouse or storage environment. In such embodiments, a forklift or other piece of equipment may implement a reference point navigation system. As the forklift traverses through designated reference point indicators within the warehouse, the system automatically performs real-time corrections, ensuring each reference point is accurately synchronized with the 3D map. Such an application provides spatial awareness and precise location tracking within complex warehouse layout.

In such an embodiment, the forklift's navigation may rely on an IMU within the navigation system in the intervals between reference point indicators. The IMU provides continuous motion data, enabling seamless and accurate navigation without direct visual or QR code guidance from the reference point indicators. The combination of real-time map correction at reference point indicator and IMU-assisted navigation offers a comprehensive and accurate navigation system applicable to efficient forklift operation in a warehouse's dynamic and densely packed spaces.

In warehouse-type environments where reference point indicators are embodied by monitors, the system can provide personalized navigation for each forklift, interfacing with the warehouse's navigation system to provide tailored directions. Such customization enhances the movement within the warehouse by considering each forklift's specific location and destination. As forklifts detect and process reference point indicators, an authentication process may verify the exact location of each forklift, ensuring accurate tracking by the warehouse management and navigation systems.

In embodies without IMU support, the system can guide forklifts to their exact destination, such as specific shelf, by providing detailed instructions based on their last known interaction with a reference point indicator. IMU technology further refines this accuracy, indicating when a forklift reaches its intended shelf for cargo handling. Despite potential decreases in navigation accuracy over distances between reference point indicators, the proximity of such reference point indicators ensures maintained reliability.

In another embodiment, the user equipment device (e.g., vehicle navigation system) initiates a journey by pre-loading locations of reference point indicators from, e.g., a specific URL. The navigation system can dynamically load locations of reference point indicators in several ways. For example, when a destination is received, the vehicle nears a road section implementing reference point navigation (e.g., as detected by GPS), or when an initial control/waypoint is scanned. If the system recognizes that necessary waypoints are not present, the system can download them on using a wireless data network (e.g., cellular connectivity to the internet). This ensures user equipment devices always have access to up-to-date navigation data. Such a URL is a portal for user equipment devices to download navigation checkpoints, which may be stored on a server in, e.g., a JSON file format containing GEO location coordinates in Decimal Degree (DD) format. Such coordinates delineate the driver's intended route, including alternative routes for possible deviations. Concurrently, based on the system's capabilities, a detailed map of the area between locations of reference point indicators may be downloaded onto the user equipment device, available in either 2D or 3D.

As the user equipment device nears locations with reference point indicators, it transitions between navigation modes to ensure continuous guidance, even when GPS signals are weak or non-existent. This transition may rely on vehicle location determined by, e.g., capturing images from reference point indicators embodied by monitors located above the road with embedded information or QR code signs, or using GPS data, or inertial navigation to refine the process.

When the system detects that the vehicle enters an area with a reference point indicator, the system aligns the vehicle's camera to determine its position relative to the initial control point. This may involve stopping near a small barrier (e.g., a sign with a QR code or monitor) and aligning the camera to detect an image displaying a URI or QR code that leads to the geolocation coordinates. Such alignment negates the need for mathematical recalculations, providing accurate navigation. Thus, as a vehicle approaches a subsequent reference point indicator, its coordinates are accurately retrieved from a database when the QR code sign or monitor's image aligns with the pre-set reference position relative to the user equipment device and/or camera. When established during initial calibration or alignment, such alignment ensures precise location determination.

In some embodiments, reference point indicators embodied by monitors positioned above roadways display landscape images. In other embodiments, such monitors can also indicate the travel directions, e.g., whether straight, left, or right, that are specifically tailored for individual user equipment device. This effectively acts as an external Heads-Up Display (HUD), leveraging monitors suspended above the road. Such personalized guidance is enabled because the highway operator's database is informed of each driver's intended route and anticipates when a particular vehicle will reach a particular reference point indicator. In such embodiments, the system provides navigational assistance and mitigates traffic congestion. Such embodiments enable the highway operator to maintain situational awareness of traffic conditions on certain sections of the road, enabling more efficient traffic management and enhanced driver guidance.

What is claimed is:

1. A method comprising:
determining, using control circuitry, a location of a user device based on location information retrieved from a first locating system;
based on determining that the user device is near an area with limited connectivity to the first locating system, retrieving, from a memory, a sparse map from a second locating system, wherein the sparse map includes mapping information related to the area with low connectivity to the first locating system;
detecting that the user device is near a reference point indicated in the mapping information of the sparse map;
detecting an indicator associated with the reference point;
retrieving, using processing circuitry, updated mapping information associated with the indicator, the updated mapping information including updated location information of the user device;
updating, using processing circuitry, the location of the user device based on the updated location information associated with the reference point; and
generating for display navigational directions based on the updated location of the user device.

2. The method of claim 1, wherein the indicator is a quick response (QR) code comprising information related to spatial coordinates related to the area with limited connectivity.

3. The method of claim 1, wherein the indicator is a wireless signal, and wherein retrieving updated mapping information comprises retrieving information from the wireless signal.

4. The method of claim 1, wherein the indicator is a wireless signal comprising information related to a uniform resource identifier (URI), and wherein retrieving updated mapping information comprises accessing information using the URI.

5. The method of claim 1, wherein the indicator is a visual object, and wherein updating the location of the user device is further based on determining the user device's location relative to the visual object.

6. The method of claim 1 further comprising:
receiving, from an inertial measurement unit (IMU) associated with the user device, IMU location information; and
calibrating the IMU location information based on the updated location of the user device.

7. The method of claim 6, wherein updating the location of the user device is further based on the IMU location information.

8. The method of claim 1, wherein the first locating system is a global positioning system (GPS).

9. The method of claim 1, wherein the navigational directions are displayed using a first application.

10. The method of claim 9 further comprising:
switching, based on determining that the user device entered the area with limited connectivity to the first locating system, from displaying the navigational directions using the first application to displaying the navigational directions using a second application.

11. A system comprising:
control circuitry configured to:
determine a location of a user device based on location information retrieved from a first locating system;
based on determining that the user device is near an area with limited connectivity to the first locating system, retrieve, a sparse map from a second locating system, wherein the sparse map includes mapping information related to the area with low connectivity to the first locating system;
detect that the user device is near a reference point indicated in the mapping information of the sparse map;
detect an indicator associated with the reference point;
retrieve updated mapping information associated with the indicator, the updated mapping information including updated location information of the user device;
update, using processing circuitry, the location of the user device based on the updated location information associated with the reference point; and
generate for display navigational directions based on the updated location of the user device.

12. The system of claim 11, wherein the indicator is a quick response (QR) code comprising information related to the area with limited connectivity.

13. The system of claim 11, wherein the indicator is a wireless signal, and wherein retrieving updated mapping information comprises retrieving information from the wireless signal.

14. The system of claim 11, wherein the indicator is a wireless signal comprising information related to a uniform resource identifier (URI), and wherein retrieving updated mapping information comprises accessing information using the URI.

15. The system of claim 11, wherein the indicator is a visual object, and wherein updating the location of the user device is further based on determining the user device's location relative to the visual object.

16. The system of claim 11, wherein the control circuitry is further configured to:
receive, from an inertial measurement unit (IMU) associated with the user device, IMU location information; and
calibrate the IMU location information based on the updated location of the user device.

17. The system of claim 16, wherein updating the location of the user device is further based on the IMU location information.

18. The system of claim 11, wherein the first locating system is a global positioning system (GPS).

19. The system of claim 11, wherein the navigational directions are displayed using a first application.

20. The system of claim 19, wherein the control circuitry is further configured to:
switch, based on determining that the user device entered the area with limited connectivity to the first locating system, from displaying the navigational directions using the first application to displaying the navigational directions using a second application.
